(19) United States
(12) Patent Application Publication
(10) Pub. No.: US 2002/0022975 A1
(43) Pub. Date: Feb. 21, 2002

(54) Networked medical information system for clinical practices

(76) Inventors: James P. Blasingame, Del Mar, CA (US); William C. Mohlenbrock, Del Mar, CA (US); Neil D. Mackenzie, San Francisco, CA (US)

Correspondence Address: LAW OFFICES OF JAMES D MCFARLAND, 12555 HIGH BLUFF DRIVE, SUITE 280 A, SAN DIEGO, CA, 92130

(21) Appl. No.: 09/854,039

(22) Filed: May 11, 2001

Related U.S. Application Data
(60) Provisional application No. 60/203,773, filed on May 12, 2000.

(51) Int. Cl. G06F 17/60

(52) U.S. Cl. 705/3

(57) ABSTRACT

A medical information (“MI”) system includes a networked server (10) providing information to patients (441) and physicians (444) prior to, during, and following an office visit. The patient connects to the MI system site, which interactively interviews the patient regarding the condition for which the patient will be seen by the physician. The MI system site generates pre-visit information including an editable preliminary chart note (180). A pre-visit physician report may include expert medical information relating to the patient's condition(s), such as differential diagnoses, work-up algorithms, treatment considerations, and literature references. A pre-visit patient summary (145) relating to the patient's condition, including key questions are provided to the patient. The pre-visit physician report may include these key questions and a rationale for each question. After examining the patient, the treating physician completes the patient's chart note, and a post-visit report (255) selected by the physician may be sent to the patient.

### CROSS-REFERENCE TO RELATED APPLICATION

Priority is hereby claimed to U.S. Provisional Patent Application No. 60/203,773, filed May 12, 2000, entitled MEDICAL INFORMATION SYSTEM FOR FACILITATING PHYSICIAN AND PATIENT INTERACTIONS USING AN ELECTRONIC NETWORK, which is incorporated by reference herein.

### BACKGROUND OF THE INVENTION

1. Field of the Invention

The invention relates to computerized medical information systems that operate over an electronic network.

2. Description of Related Art

The emergence of the Internet has been accompanied by widespread enthusiasm. Fast, inexpensive communication between high-speed computers connected to the Internet enable a wide variety of uses; accordingly a wide variety of applications have been developed, such as online merchandising, financial, and information services. The Internet has markedly enhanced the flow of information in many areas.

One important Internet application is healthcare. Currently, a number of websites are providing educational health content to anyone who takes the time to sign on. However, there are very few and very limited practical applications that help the physician when seeing patients. Most current applications either service the business side of the doctor's office or provide some form of educational content. Both are valuable but neither is of direct benefit to the physician when seeing patients. Although a majority of physicians are Internet users, only a small fraction use the Internet to help with patient care. However, even that small percentage of physicians who use the Internet to help with their practices, use it only in a limited fashion. For example, a physician may use the Internet for literature searches or for online pharmacy applications.

Considering the explosion of medical knowledge and the frequent patient complaints about physicians who do not keep up on current treatment recommendations, it is surprising that Internet usage in practice is as low as it is. Currently, there are no compelling and practical Internet applications specifically designed to assist the physician while seeing patients. Available products include applications such as Internet transcription, electronic medical records, online prescriptions, scheduling programs, electronic billing programs, and literature search engines, but none is designed to assist both the physician and patient in conjunction with a patient visit.

### SUMMARY OF THE INVENTION

The medical information system described herein assists in the flow of general and condition-specific information useful for the patient-physician interaction, and also helps both the patient and physician at the time of an office visit, and also assists both before and after the visit. In some embodiments, the patient and physician can view the medical information system as an extension of the physician's office. This approach can bring together the patient, the patient's information, the physician, and condition-specific education to the same place at the same time, which benefits both the patient and physician. For example, the patient receives accurate treatment in an efficient manner, and the physician is continually educated about current, up-to-date medical treatments and techniques. Of course, appropriate security compliance provided to ensure patient's privacy.

The medical information system (MI system) includes a networked server that provides information over the network to physicians and patients. In one embodiment, a patient schedules an appointment with a physician, who enables the patient's access to the MI system site. The physician's office enables (selects) medical conditions that the patient is known to have (or may have). The patient then connects to the MI system site, and the MI system site interactively interviews patient regarding the enabled condition and then stores information from the patient regarding the condition in patient files at the server site. Responsive to the interview, the MI system site electronically generates pre-visit information that includes an editable preliminary chart note including information relating to the patient's condition. After examining the patient, the treating physician completes the patient's chart note responsive to the examination, and the completed chart note is stored at the MI system site. By assisting the physician in creating the chart note, the MI system can save substantial physician time and reduce medical transcription costs. In some embodiments the pre-visit physician report transmitted to the physician also includes expert medical information relating to the patient's condition(s), such as differential diagnoses, work-up algorithms, treatment considerations, and literature references. By educating and assisting the treating physician at the point of care, the physician can provide high quality medical services.

In some embodiments the method further comprises electronically generating pre-visit information that includes a pre-visit patient summary responsive to the interview including information relating to the patient's condition, and then transmitting the pre-visit patient summary to the patient. Furthermore, in some embodiments the transmitted pre-visit patient summary further comprises medical “key” questions relating to the patient's condition(s), and the pre-visit physician report transmitted to the physician includes the key questions and a rationale for each of the questions. The key questions are a set of simple, guiding questions (for example 3-5 questions) for the patient to ask the physician at the upcoming visit. These questions are designed to focus the office visit. A typical key question is simple and short, and covers informational items that the physician would usually want to cover during the office visit. The patient should feel comfortable asking the physician these questions. These key questions give the patient some direction for the visit and help the physician by keeping the visit focused. Thus, the patient receives condition-specific educational resources prior to the scheduled appointment, and can arrive at the appointment better prepared for the office visit with the physician.

The MI system site enables any subscribing physician to easily utilize the expertise of medical experts and the latest medical research at the point of care. The MI system site can be quickly updated with the latest and newest medical practices, and thus the information provided to the physician can be regularly updated with the latest medical practices that may otherwise be difficult or impractical to obtain, providing benefits both to the physician and patient seeking treatment from that physician. The patient benefits by receiving high quality treatment using the latest medical practices, directed to the patient and the patient's condition.

In summary the MI system collects patient-specific and condition-specific information, and uses this information to prepare both the patient and physician for the office visit, and to create a preliminary chart note for the physician. Thus, the needs of physicians and patients are addressed at the point of care. The MI system can also provide instant access to research and relevant literature related to the patient's medical condition. Following the visit, the MI system can provide post-visit patient education and instructions. Also, it can be used to monitor the patient's health and satisfaction. Furthermore, the MI system provides improved documentation of the patient's condition(s), diagnosis, and treatment, which can reduce malpractice risk. The documentation provided by the MI system also reduces repetitive and mundane paperwork.

### BRIEF DESCRIPTION OF THE DRAWINGS

For a more complete understanding of this invention, reference is now made to the following detailed description of the embodiments as illustrated in the accompanying drawings, wherein:

FIG. 1 illustrates the general architecture of a networked medical information system (MI system) that operates in accordance with the present invention;

FIG. 2 is a data flow diagram illustrating data flow and data structures relating to MI system processes;

FIG. 3 is a diagram of processes and related data pertaining to preparation by a patient and by a physician for an office visit;

FIG. 4 is a diagram of processes and related data relating to the actual office visit between a patient and physician, and also relating to generating the final report and completing the physician's chart note;

FIG. 5 is a data flow diagram of processes relating to data access to patient's files, and also showing search resources available to physicians and patients who are registered into the MI system;

FIG. 6 is a functional block diagram that shows a plurality of users connected via a plurality of communication links to an MI system site in one implementation 400, illustrating that the MI system site can be utilized by a variety of users using a plurality of suitable communication links supported by the MI system site;

FIG. 7A is first page of an example of a screen display for a demographic interview of a patient;

FIG. 7B is a second page of the demographic interview of FIG. 7A;

FIG. 7C is a third page of the demographic interview of FIG. 7A;

FIG. 8A is an example of a screen display for health history interview;

FIG. 8B is a second page of the health history interview of FIG. 8A;

FIG. 8C is a third page of the interview of FIG. 8A;

FIG. 8D is a fourth page of the health history interview of FIG. 8A;

FIG. 8E is a fifth page of the health history interview of FIG. 8A;

FIG. 9A is a first page of an example of a screen display of an interview relating to a patient's body systems;

FIG. 9B is a second page of the interview of FIG. 9A;

FIG. 9C is a third page of the interview of FIG. 9A;

FIG. 10A is first page of an example of a screen display for a condition-specific interview;

FIG. 10B is a second page of the interview of FIG. 10A;

FIG. 10C is a third page of the interview of FIG. 10A;

FIG. 10D is a fourth page of the interview of FIG. 10A;

FIG. 11 is an example of a screen display of a page that assists the patients in the registration process;

FIG. 12 is an example of a screen display that assists a patient in updating personal information;

FIG. 13 is an example of a screen display for a roster of patient appointments for a medical center;

FIG. 14 is an example of a screen display of a list of physicians associated with the medical center of FIG. 13;

FIG. 15A is a screen display used by a patient in connection with authorizing a selected physician to access a patients medical records;

FIG. 15B is a second page of FIG. 15A;

FIG. 16A is the first page of an example of a pre-visit patient summary;

FIG. 16B is a second page of FIG. 16A;

FIG. 17A is an example of a pre-visit condition-specific physician report relating to hip pain;

FIG. 17B is a second page of the report of FIG. 17A;

FIG. 17C is a third page of the report of FIG. 17A;

FIG. 17D is a fourth page of the report of FIG. 17A;

FIG. 18A is an example of a pre-visit condition specific physician report;

FIG. 18B is a second page of the report of FIG. 18A;

FIG. 18C is a third page of the report of FIG. 18A;

FIG. 19A is an example of a preliminary chart note for a patient with knee pain;

FIG. 19B is a second page of the chart note of FIG. 19A;

FIG. 20A is an example of a screen display used by a physician to generate a post-visit patient report;

FIG. 20B is a second page of the screen display of FIG. 20A;

FIG. 21A is an example of a post-visit patient report;

FIG. 21B is a second page of the report of FIG. 21A;

FIG. 22A is an example of a partially completed chart note for hip pain;

FIG. 22B is a second page of the chart note of FIG. 22A;

FIG. 22C is a third page of the chart note of FIG. 22A; and

FIG. 22D is a fourth page of the chart note of FIG. 22A.

### DETAILED DESCRIPTION

This invention is described in the following description with reference to the figures, in which like numbers represent the same or similar elements.

### Glossary of Terms and Acronyms

The following terms and acronyms are used throughout the detailed description:

Client-Server. A model of interaction in a distributed system in which a program at one site sends a request to a program at another site and waits for a response. The requesting program is called the “client,” and the program that responds to the request is called the “server.” In the context of the World Wide Web (discussed below), the client is a “Web browser” (or simply “browser”) that runs on a computer of a user; the program which responds to browser requests by serving Web pages is commonly referred to as a “Web server.”

Condition. Any illness, disease, symptom, injury, procedure, or other medical indication. For example, a patient seeks treatment for a medical condition, and condition-specific reports are generated for that medical condition. Other examples include a traditional illness or disease (such as diabetes), a symptom (such facial pain), an injury (such as wrist fracture), health maintenance (such as an annual exam), a congenital anomaly (such as cleft palate), a procedure (such as hip replacement), and a condition (such as internal tibial torsion).

Content Physician. A medical expert who creates and maintains condition-specific medical information and interviews in the MI system. Certain medical information is intended for patients; other medical information is intended for physicians.

Treating Physician. The physician at the point of care; i.e. the physician who examines and diagnoses the patient.

Differential diagnoses: This is an organized list of the possible causes of any medical condition (usually symptoms). It is usually presented in outline format.

Work-up algorithm: A work-up algorithm outlines an organized approach for determining the cause of a symptom or other medical condition. It is often in a yes/no decision tree format, but can be presented in various formats.

Treatment algorithm: A treatment algorithm outlines an organized approach to the care of a known condition/illness. It is usually organized in a manner that starts with the most basic and simple care, follows the response to this care and then progresses to further care modalities if the response to the first treatment is not satisfactory. For purposes herein, treatment considerations can be thought of as a synonym of treatment algorithm.

Hyperlink. A navigational link from one document to another, or from one portion (or component) of a document to another. Typically, a hyperlink is displayed as a highlighted word or phrase that can be selected by clicking on it using a mouse to jump to the associated document or documented portion.

Hypertext System. A computer-based informational system in which documents (and possibly other types of data entities) are linked together via hyperlinks to form a user-navigable “web.”

Internet. A collection of interconnected (public and/or private) networks linked together and communicating using a set of standard protocols (such as TCP/IP and HTTP) to form a global, distributed network. (While this term is intended to refer to what is now commonly known as the Internet, it is also intended to encompass variations that may be made in the future, including changes and additions to existing standard protocols.)

World Wide Web (“Web”). Used herein to refer generally to both (i) a distributed collection of interlinked, user-viewable hypertext documents (commonly referred to as Web documents or Web pages) that are accessible via the Internet, and (ii) the client and server software components which provide user access to such documents using standardized Internet protocols. Currently, the primary standard protocol for allowing applications to locate and acquire Web documents is HTTP, and the Web pages are encoded using HTML. However, the terms “Web” and “World Wide Web” are intended to encompass future languages and transport protocols that may be used in place of (or in addition to) HTML and HTTP, such as XML (eXtensibile Mark-up Language) and WAP (Wireless Access Protocol).

Network Site. A computer system that serves informational content over a network using the standard protocols such as those of the World Wide Web. On the Internet, a network site typically corresponds to a particular Internet domain name, such as “company.com,” and includes the content associated with a particular organization. As used herein, the term is generally intended to encompass both (i) the hardware/software server components that serve the informational content over the network, and (ii) the “back end” hardware/software components, including any non-standard or specialized components, that interact with the server components to perform services for Web site users.

HTML (HyperText Markup Language). A standard coding convention and set of codes for attaching presentation and linking attributes to informational content within documents.

HTTP (HyperText Transport Protocol). The standard World Wide Web client-server protocol used for the exchange of information (such as HTML documents, and client requests for such documents) between a browser and a Web server. HTTP includes a number of different types of messages that can be sent from the client to the server to request different types of server actions.

### Overview of System Components and Operation

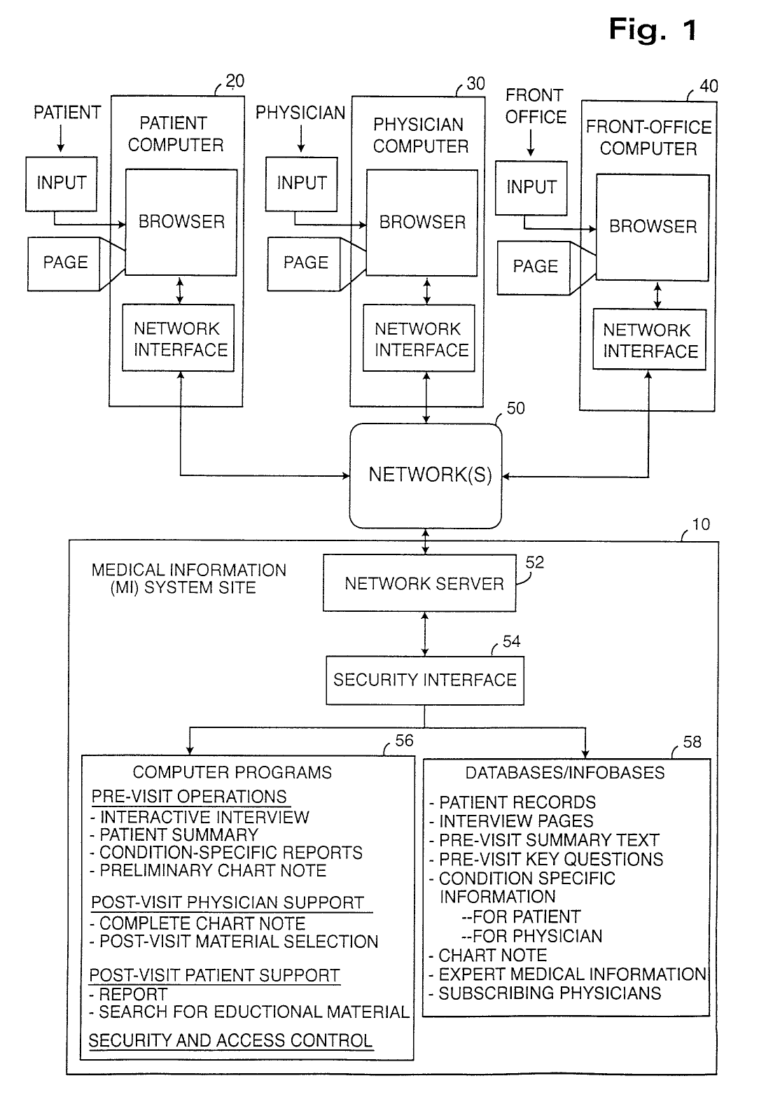

The medical information system described herein can be implemented in a wide variety of forms. FIG. 1 illustrates the general architecture of a networked medical information system (MI system) that operates in a client-server arrangement in accordance with the present invention. Using this general architecture, a wide variety of functions can be accomplished.

The system includes a medical information system (MI system) server site 10 and a plurality of clients such as a patient computer 20, a subscribing physician's computer 30, and a physician's front office computer 40, all of which are linked together by a network 50 such as the Internet. As defined herein, the client is the device that communicates with the MI system site; a user is the person such as a patient, physician, or front office personnel operating the client device. Each client computer includes a network interface for connecting the respective computer with the network, a browser to receive and display information received from the network in the form of pages, and an input system to the browser, which allows the user to respond to requests from the MI system site and, also allows the user to input information via the browser and network interface.

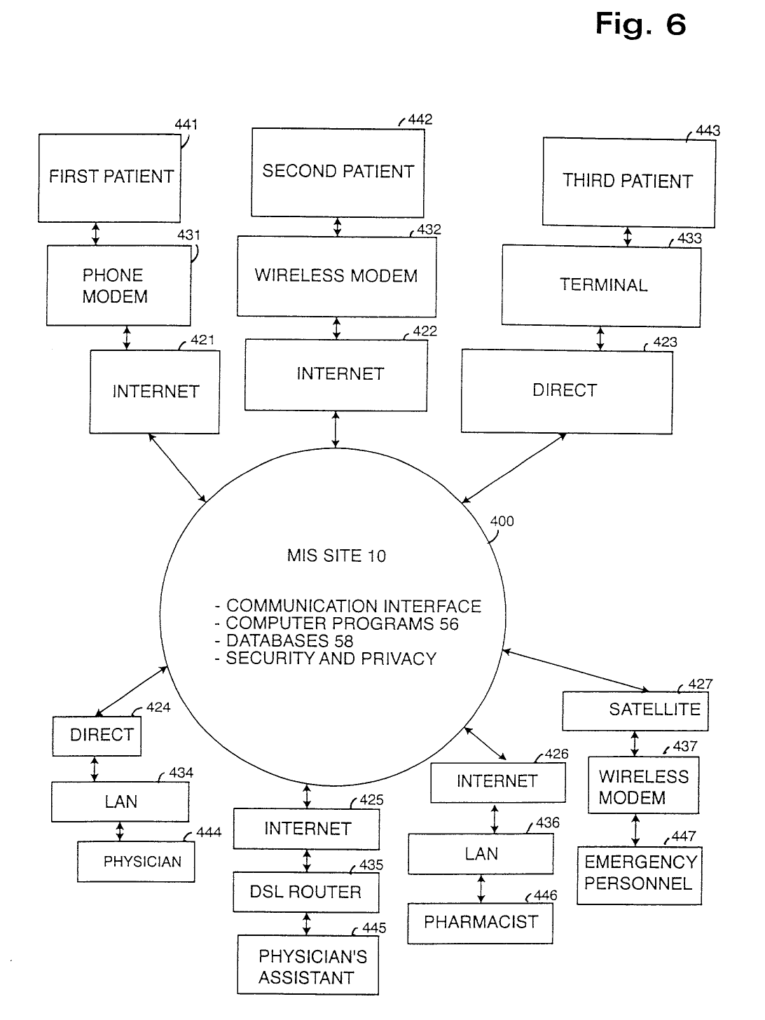

The network 50 can have a wide variety of configurations for connecting the client computers to the MI system server site; for example the MI system server site 10 may be connected to the Internet, the patient computer 20 may have a modem connection to the Internet, and the physician and front office computers 30 and 40 may be part of a local area network (LAN) that uses a router to connect its computers with the Internet. In another example, a single LAN connects the server, physician, and front office computers, and the patient computer may connect into the LAN via a dial-up connection; alternatively the patient can enter data on a dedicated terminal within the LAN. It should be apparent that a wide variety of configurations can be implemented. Other examples of users and communication links are shown in FIG. 6 and discussed with reference thereto.

The network 50 is typically implemented by one or more wired and/or wireless network links having an associated bandwidth or data rates. Conventionally, the network operates using shared communication protocols and standards; for example, communication may include requests from client's computers and responses from the MI system server 52 using the hypertext transport protocol (HTTP). Specifically, any of the client's computers may request pages or other information from the MI system server, and in response the MI system server provides the requested pages and information. The pages may be linked by hyperlinks, and the resulting informational system is a hypertext system. The MI system server can also send information to one or more of its subscriber physicians, and/or to one or more of its patient.

Generally, the computers used by clients for connecting to the network include any device capable of connecting to the MI system server site and communicating the client's directions or commands; examples of such computers include high and low end computer workstations, computer laptops or notebooks, palmtops, personal digital assistants (PDAs) and terminals. The patient computer may be any type of computing device that allows a user (“customer”) to connect with another computer, such as via a direct connection, or via the Internet. For example, the patient computer may be a personal computer (PC) that runs the Windows NT® or Macintosh® operating system. In typical operation, the patient accesses the MI system using a standard Web browser, such as Microsoft's Internet Explorer® or Netscape's Navigator®, which uses the HTTP protocol to communicate with a Web server at the MI system. In such an embodiment, the Web server accesses documents (in the form of HTML or “Web” documents) that can be requested, retrieved and viewed by the client via the browser. For example, hyperlinks embedded in a page can be used to quickly access a number of documents (or portions of a document).

The MI system site utilizes the server 52 to interface with the clients on the network. At any time during operation, the network may simultaneously connect the server with a plurality of patients, physicians, and front offices. In some embodiments for large-scale use, the MI system server site may comprise a plurality of computers and a plurality of servers designed to meet the requirements for communication with a large number of clients connected to the MI system server site.

In general, the MI system site utilizes the server 52 to serve information from databases to client computers, subject to control by computer programs 56. In order to control access to the computer programs, access to private medical information, and access to other information stored within the databases, the MI system site includes a security interface 54 between the network server 52 and the computer programs 56 and databases 58. This security interface can have a variety of forms, such as firewalls and filters. Once through initial security interface, access to individual data is controlled via appropriate security and access programs at the server site.

The information served by the MI system site includes a wide variety of medical information stored in databases 58 including patient files, interview pages, pre-visit summary text, pre-visit key questions, condition-specific information for patients and physicians, chart note forms, expert medical information, and list(s) of subscribing physicians. The medical information is served subject to the control of programs 56 that provide the desired function, such as an interactive interview program, a pre-visit summary patient summary program, report generation programs to generate condition-specific reports for patients and for physicians, a chart note generation program that generates preliminary chart notes based upon the information provided by the patient, a program to allow the physician to select post-visit information and provide it to the patient, and search programs for providing educational material to patients and physicians.

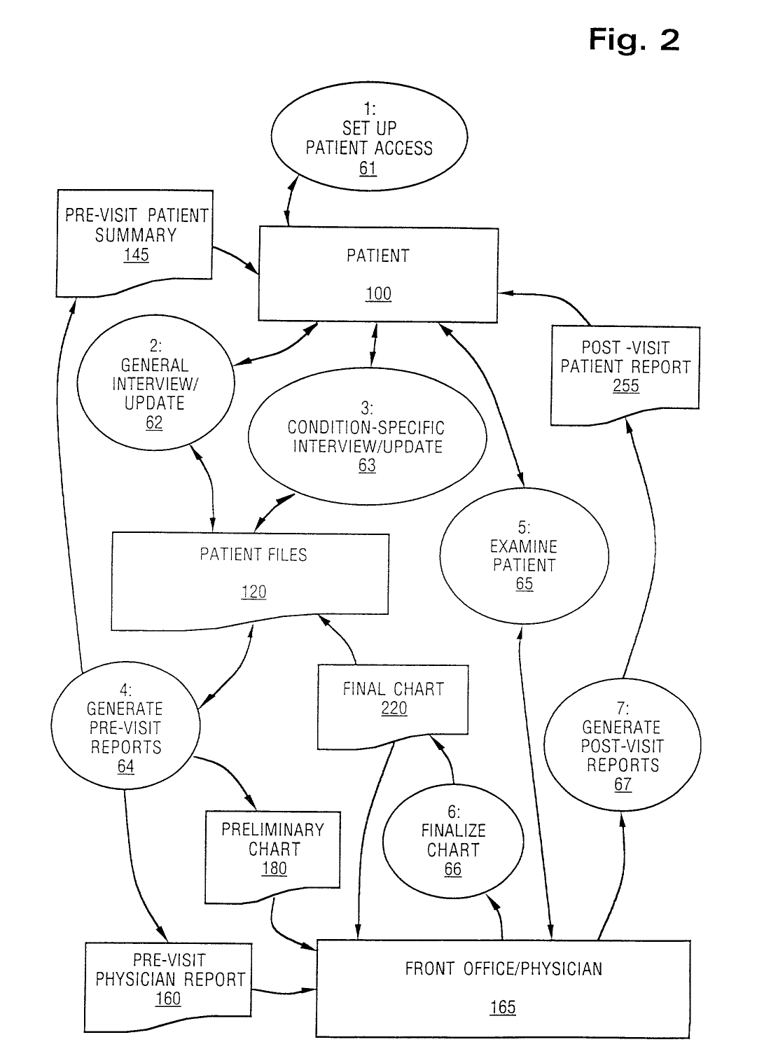

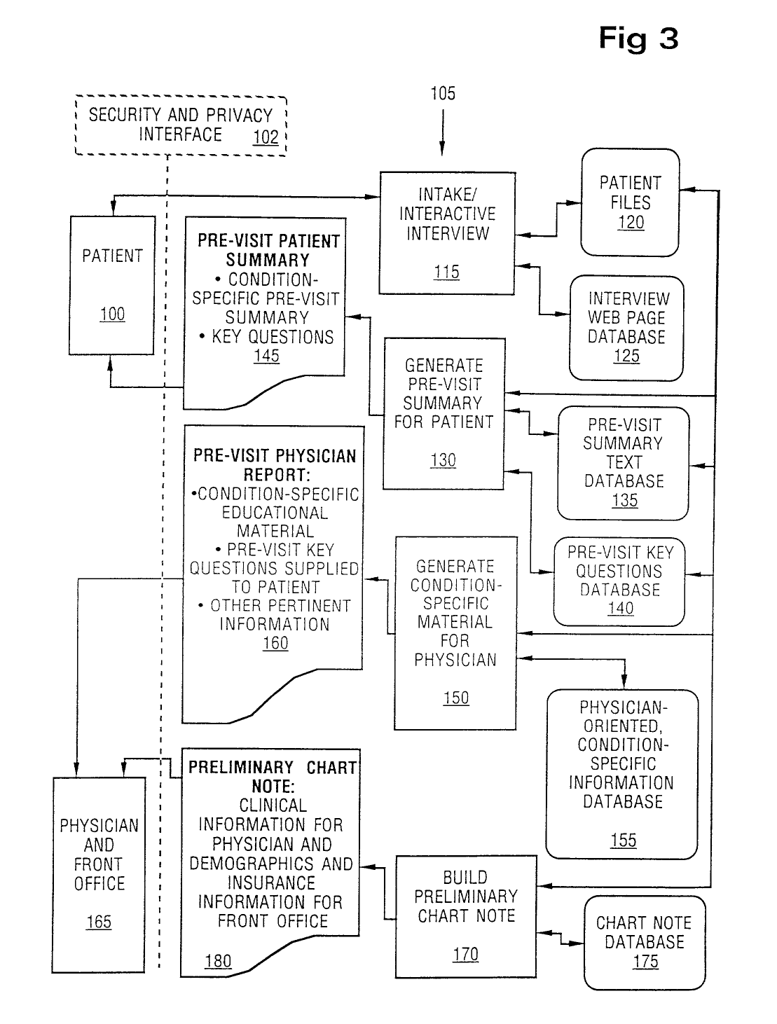

FIG. 2 is a data flow diagram of one embodiment of an MI system, simplified for the purpose of providing a high-level illustration of data flow and data structure. Detailed information relating to the processes and data structures is provided elsewhere, for example with reference to FIGS. 3, 4, and 5.

In FIG. 2, a patient 100 may first request access information from a first process 61 in order to log on to the MI system server, and in response the patient 100 receives access information including an access code and other information. For example, if the patient is a new patient who will be accessing the MI system site over the worldwide web, then the new patient may be given a URL, a temporary user name, and a temporary password that will be used to log on to the MI system server. The first process 61 may be provided by the physician's front office or from some other suitable source in response to a request by the patient. A returning patient may already have access information. The patient then uses this access information to log on to the MI system server 52 (FIG. 1).

In one example, a subscribing physician's office is contacted by a patient who has a specific health complaint. The patient is given an appointment time for an office visit with the physician and, if the patient is new, instructions regarding how to log on to the MI system server, and a security code. The subscribing physician's office then logs on to the MI system server, and enables the MI system for this patient; i.e., the office notifies the MI system site that this patient (who may be identified by user name) will be signing on for an interview. Based upon the patient's health complaint, the physician's office may also select one or more conditions for which the patient should be interviewed by the MI system site (i.e. the physician's office enables certain medical conditions for the interview).

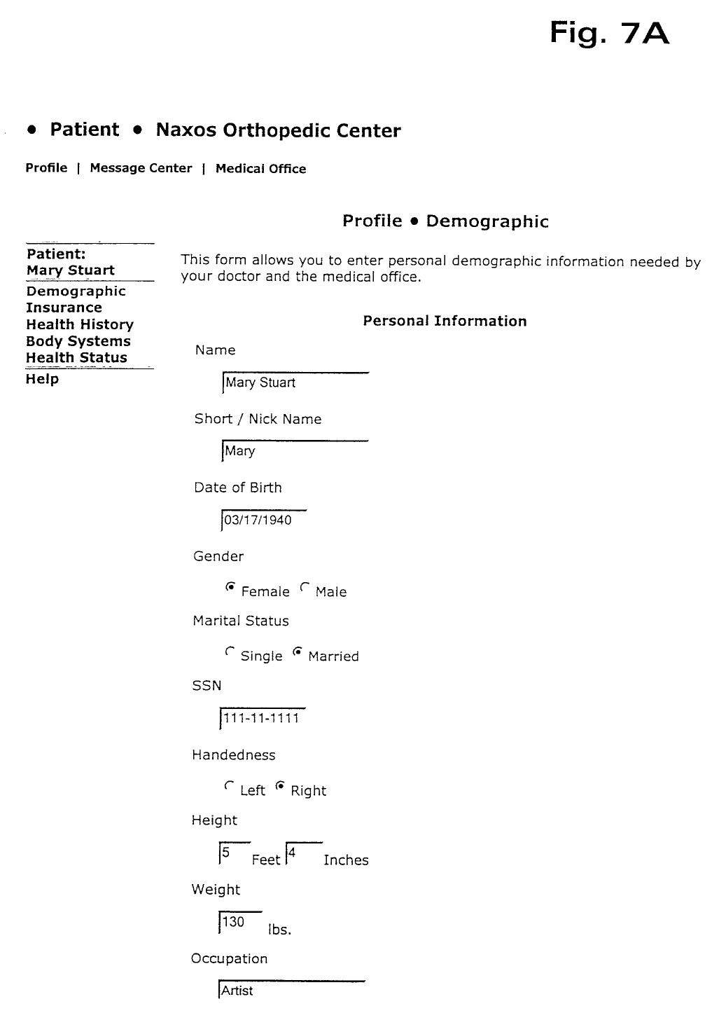

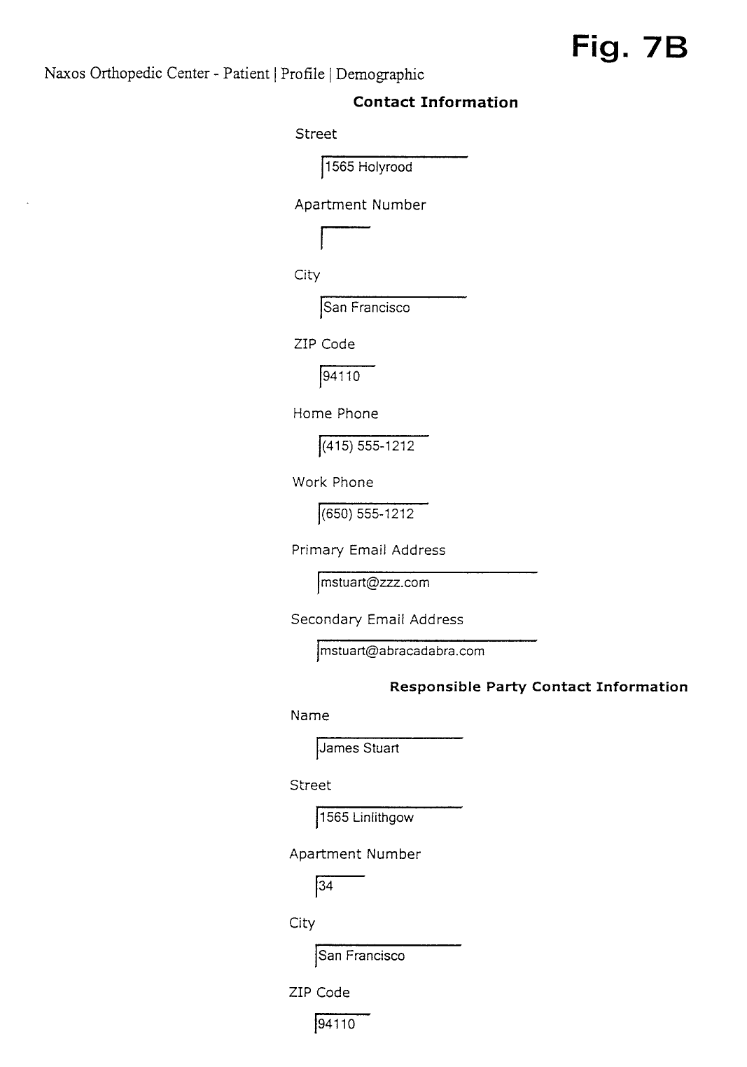

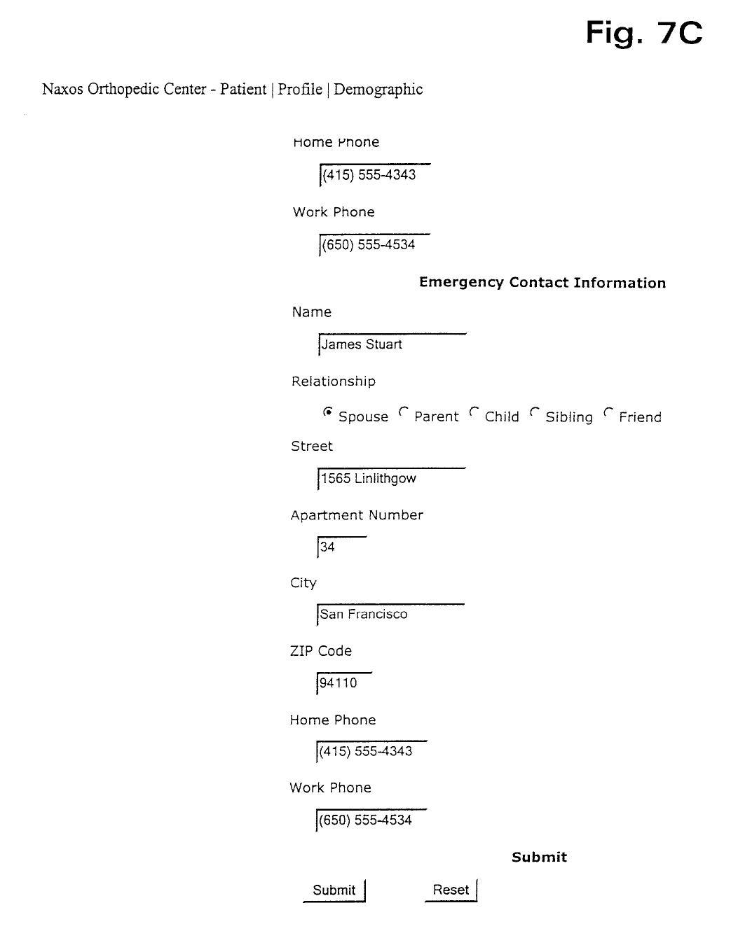

Once the patient has logged on to the MI system server, a second process 62 including a general interview of the patient is initiated. A new patient will be asked by the MI system site to provide information relating to the patient's personal and heath status, such as demographics, health history, and body systems, as described with reference to FIGS. 7A-C, 8A-E, and 9A-C, for example. A returning patient may be asked to verify the information currently on file. The information from the general interview is stored in the patient files.

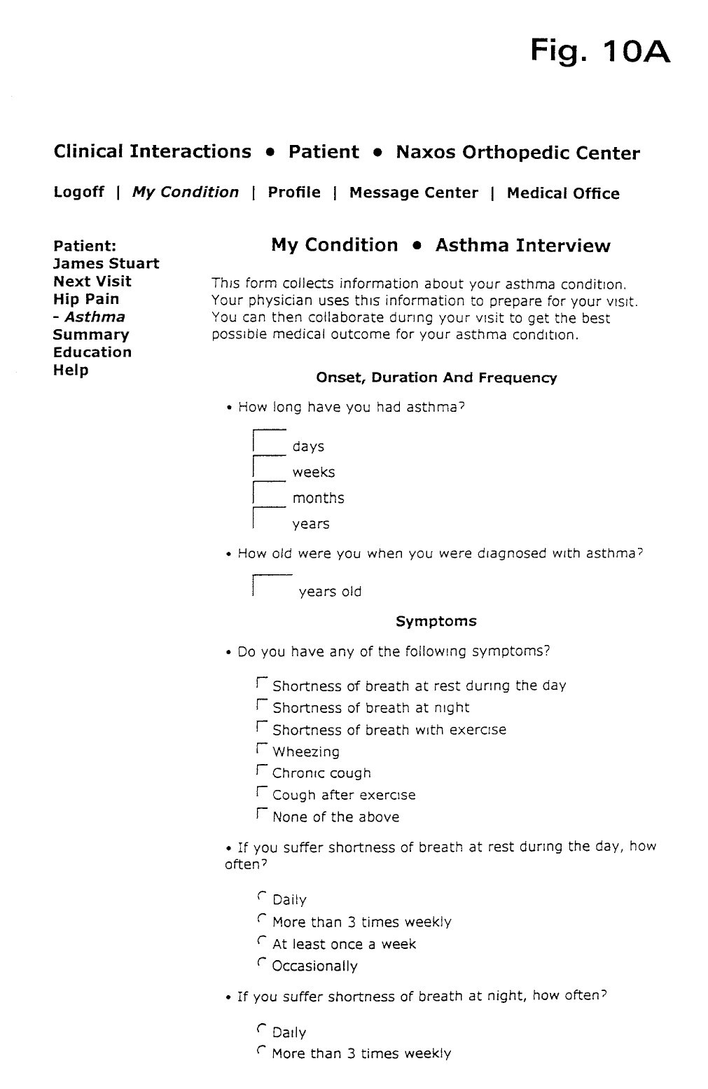

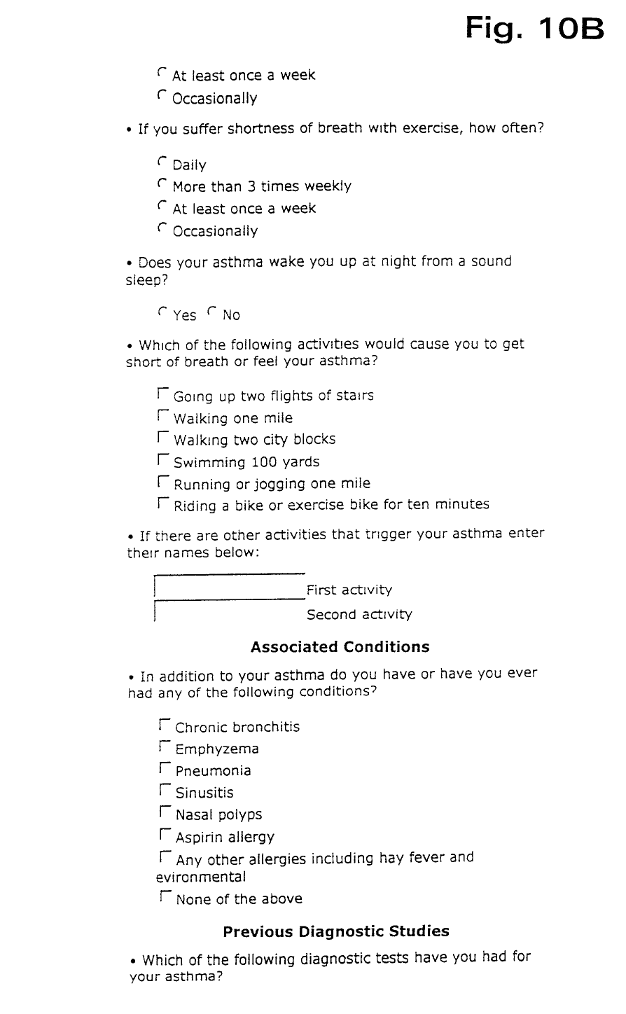

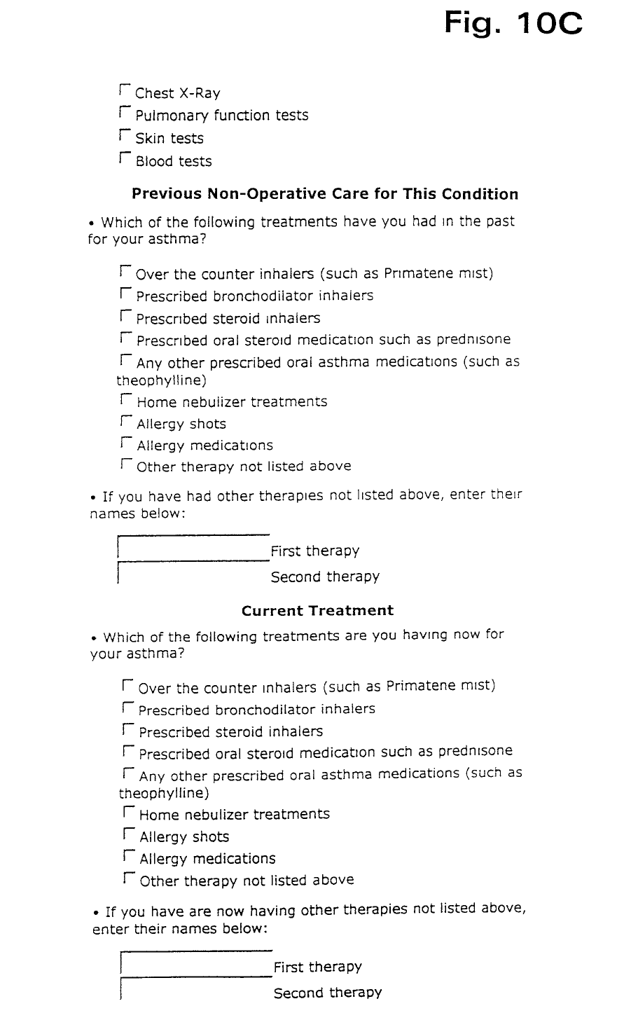

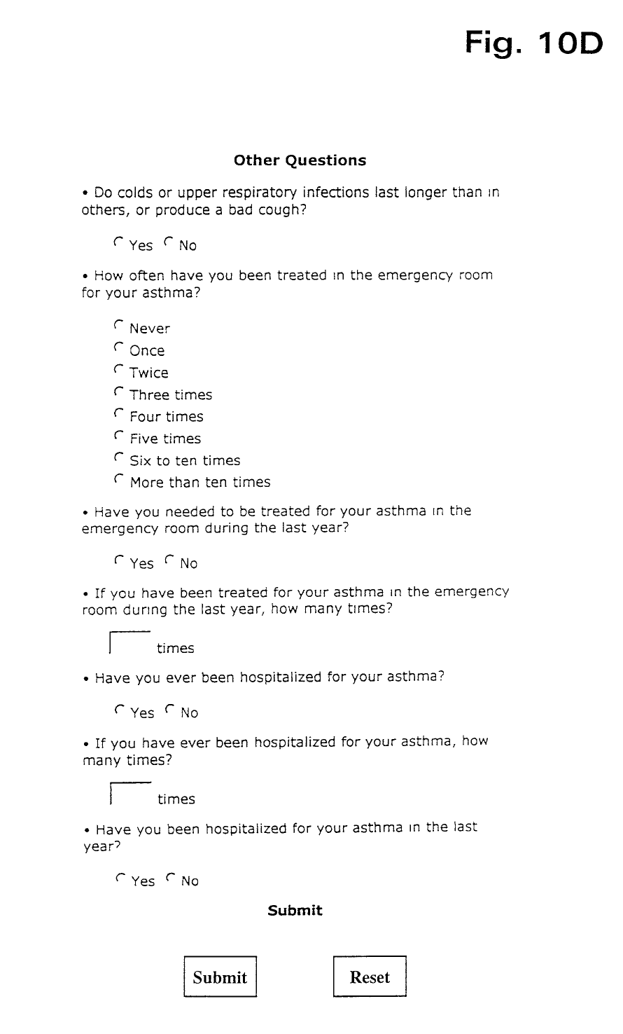

In one embodiment, depending upon the conditions enabled by the physician, the MI system site then initiates one or more condition-specific interviews of the patient, as shown by a third process 63. In some embodiments, condition-specific interviews may be initiated for other reasons, such as information supplied by the patient during the interview Particularly, a condition-specific interview may be initiated for a variety of reasons, such as a specific complaint by the patient for which treatment is sought, a patient's history, an answer to a general question, or an on-going health problem. An example of condition-specific interview for a patient with asthma is described with reference to FIGS. 10A-10D. Depending upon the needs of the patient, two or more condition-specific interviews may be conducted; for example a patient seeking treatment for a back problem with a history of heart problems may be interviewed for both the back problem and the heart problem. If the patient is a returning patient, and the condition is an on-going problem, then the patient may be asked to verify the information currently on file and update it as necessary. The information from the condition-specific interview is stored in the patient files.

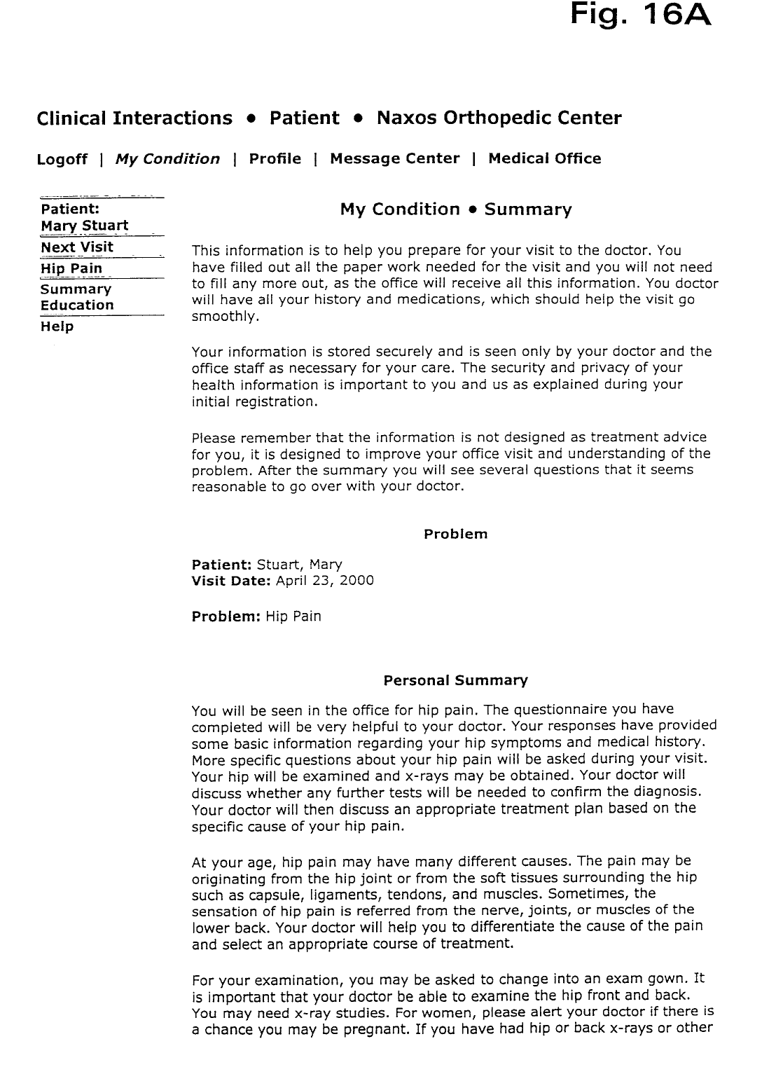

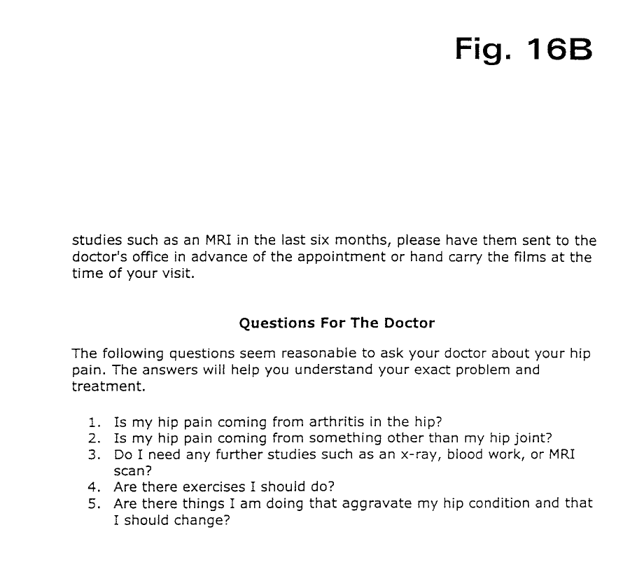

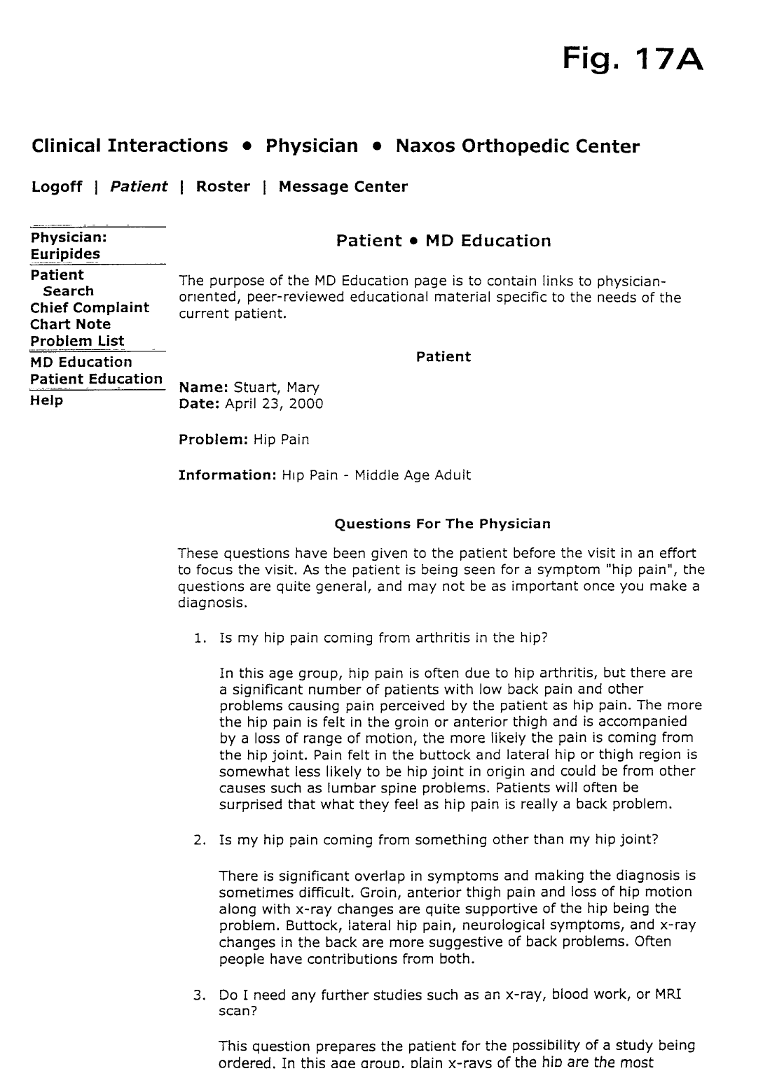

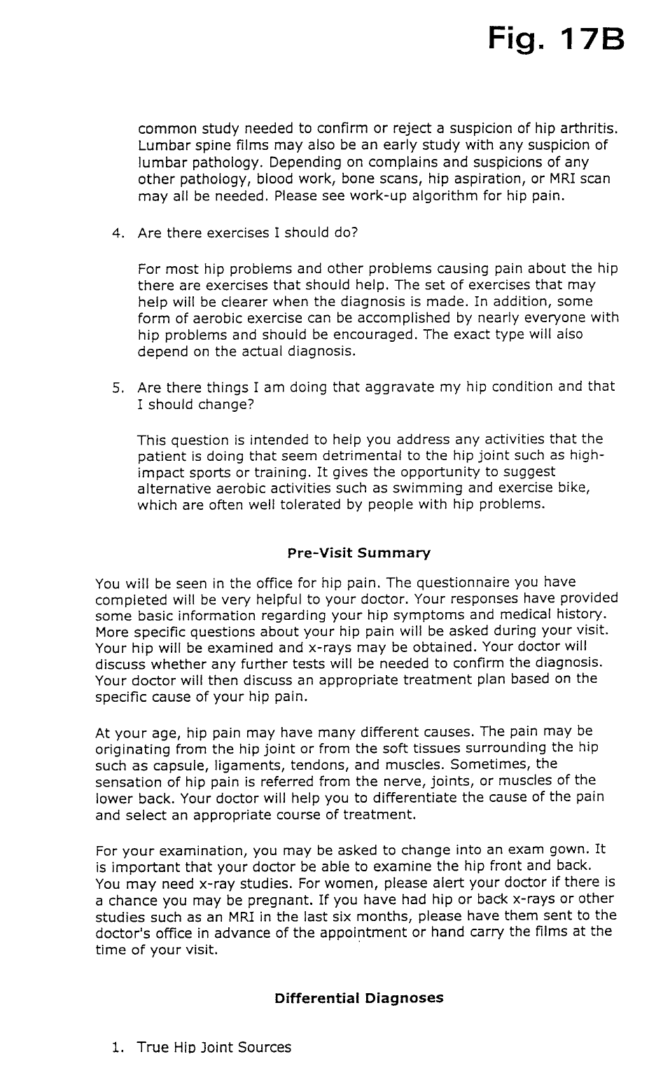

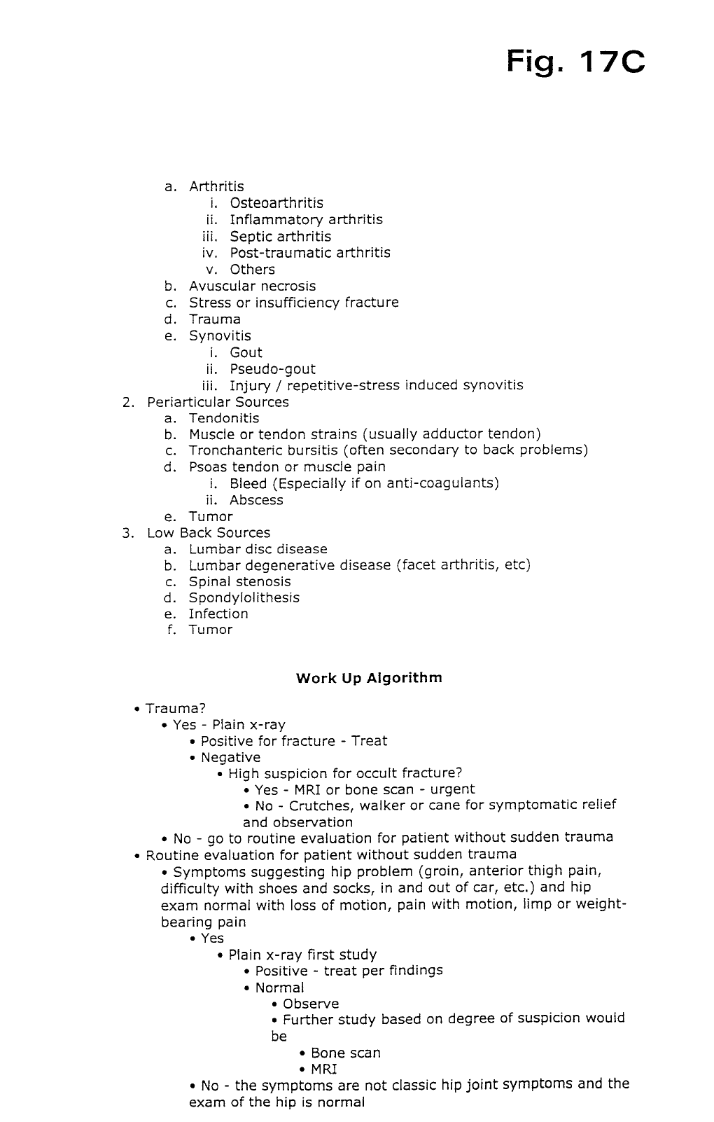

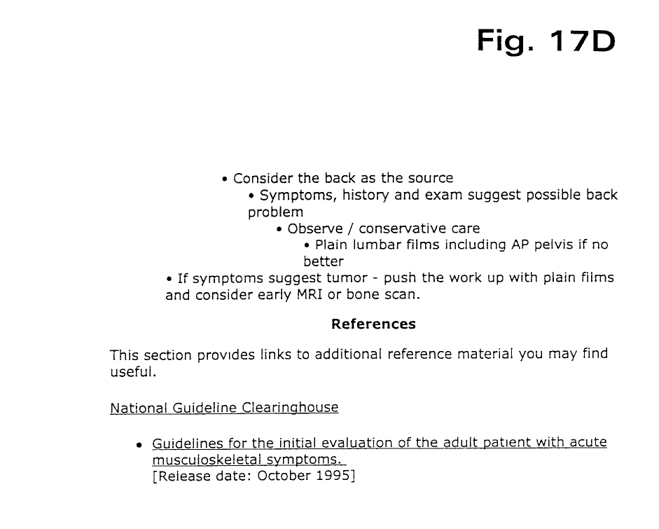

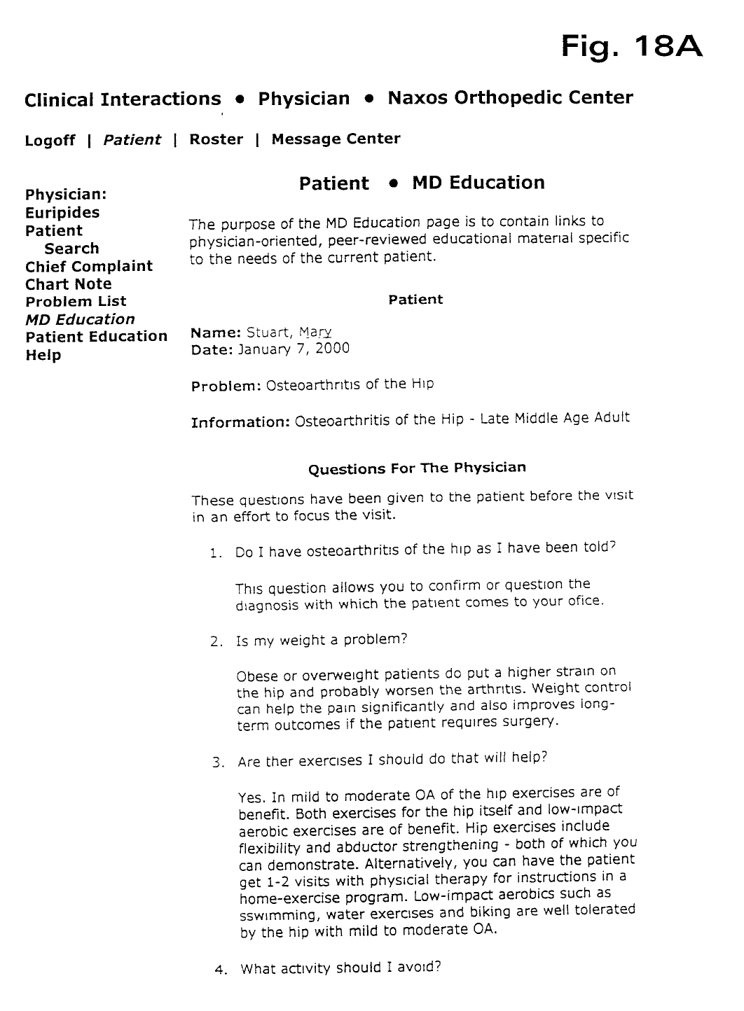

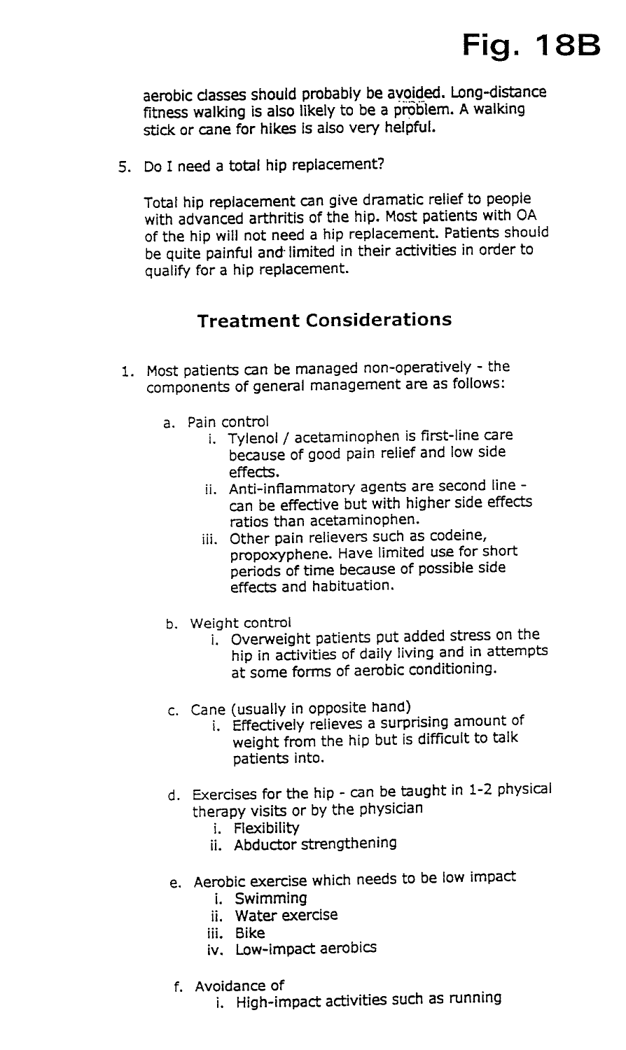

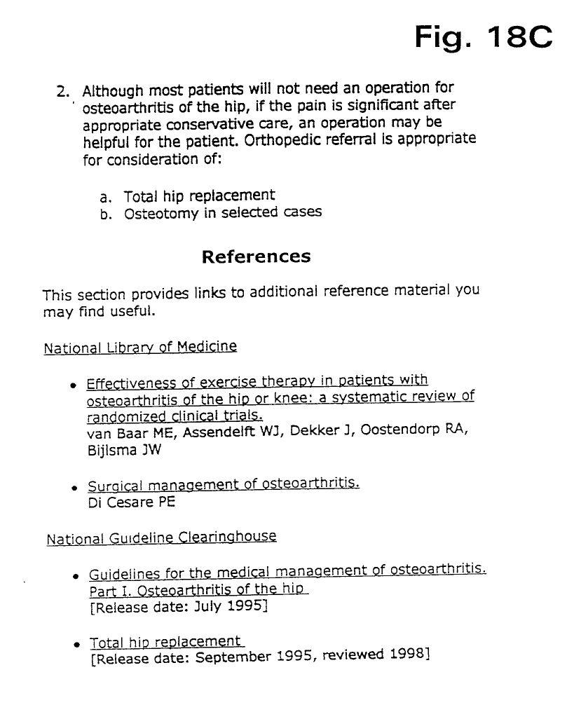

Using the information supplied by the patient during the interviews, the MI system site generates pre-visit reports in a fourth process 64. The pre-visit reports include a pre-visit patient summary 145 supplied to the patient 100, which educates the patient in anticipation of a visit with a physician, and may include key questions to ask the physician. An example of a pre-visit patient summary is shown at FIGS. 16A and 16B. A physician and/or front office 165 receives a preliminary chart note 180, a pre-visit physician report 160, and other patient information, which prepares the front office and the physician for the patient's office visit. Examples of condition-specific physician material are shown in FIGS. 17A-D (hip pain), and FIGS. 18A-C (osteoarthritis of the hip). Advantageously, the front office receives essential patient information such as demographics and insurance, and the physician receives up-to-date medical and educational information such as expert medical information, the latest medical practices, and differential diagnoses that are useful for diagnosing and defining a treatment for the patient, thus allowing the physician to provide a high level of care in an efficient manner.

Once all the pre-visit reports have been distributed, the patient is ready to visit with the physician, and likewise the physician is ready to examine the patient. As illustrated in a fifth process 65, the physician examines the patient during an office visit. In addition to information verbally provided by the patient, examination processes may include observations by the physician and one or more medical tests. If necessary or useful, the examination may extend over two or more time periods. Based upon this examination, the physician makes a diagnosis and recommends an appropriate treatment. The physician may communicate some or all of this information to the patient at the examination, and some or all may be provided later, as described herein.

After the patient's visit, the physician then initiates a sixth process illustrated at 66, to provide a final chart note 220, building upon the preliminary chart note. If the patient is being seen for multiple conditions, this process may include completing a chart note for each condition. The chart note may be completed by an assistant in the front office, for example, the physician may dictate notes that are transcribed into the chart note by a medical transcriptionist. The final chart note(s) are stored in the patient's files 120, and the front office 165 keeps a copy for the physician's record-keeping requirements.

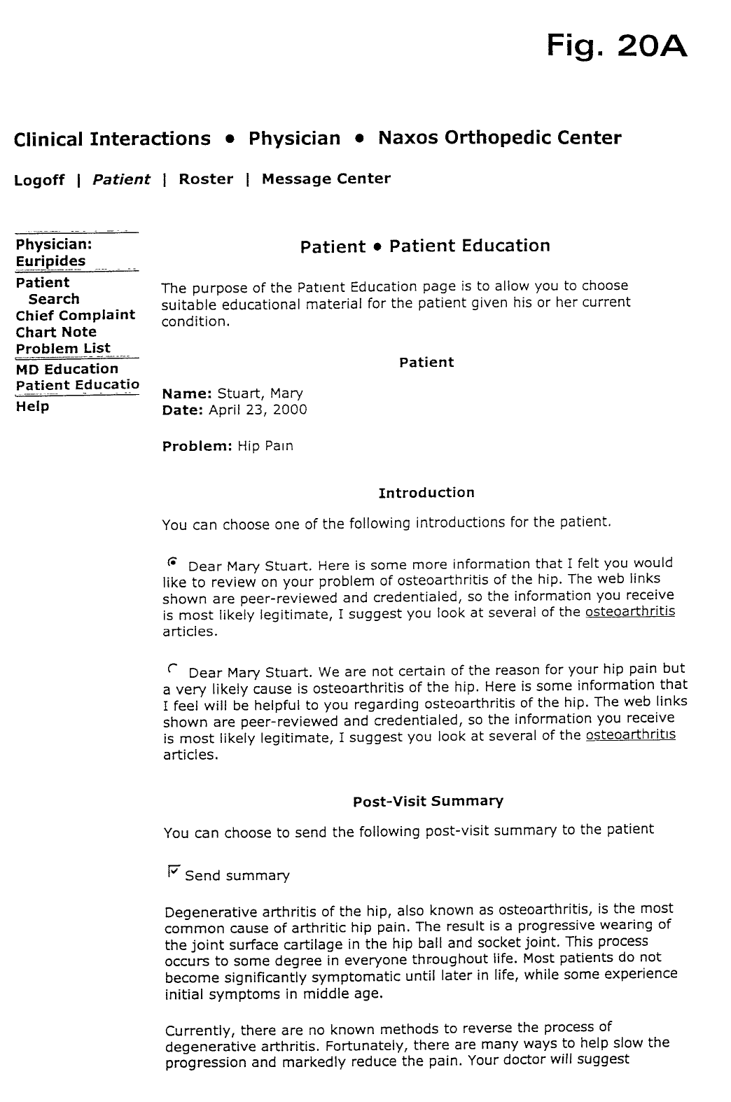

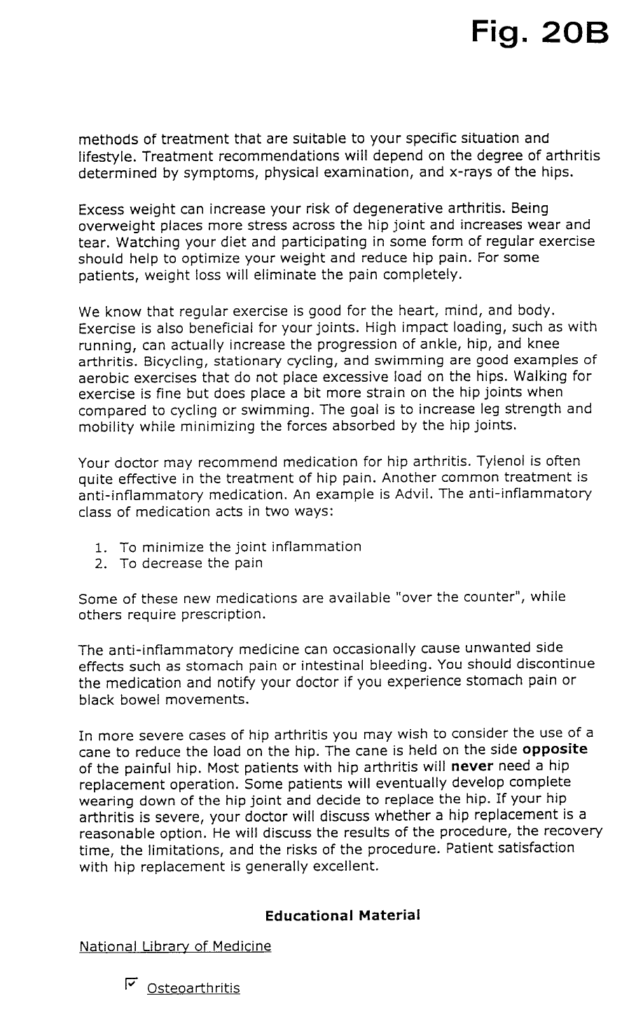

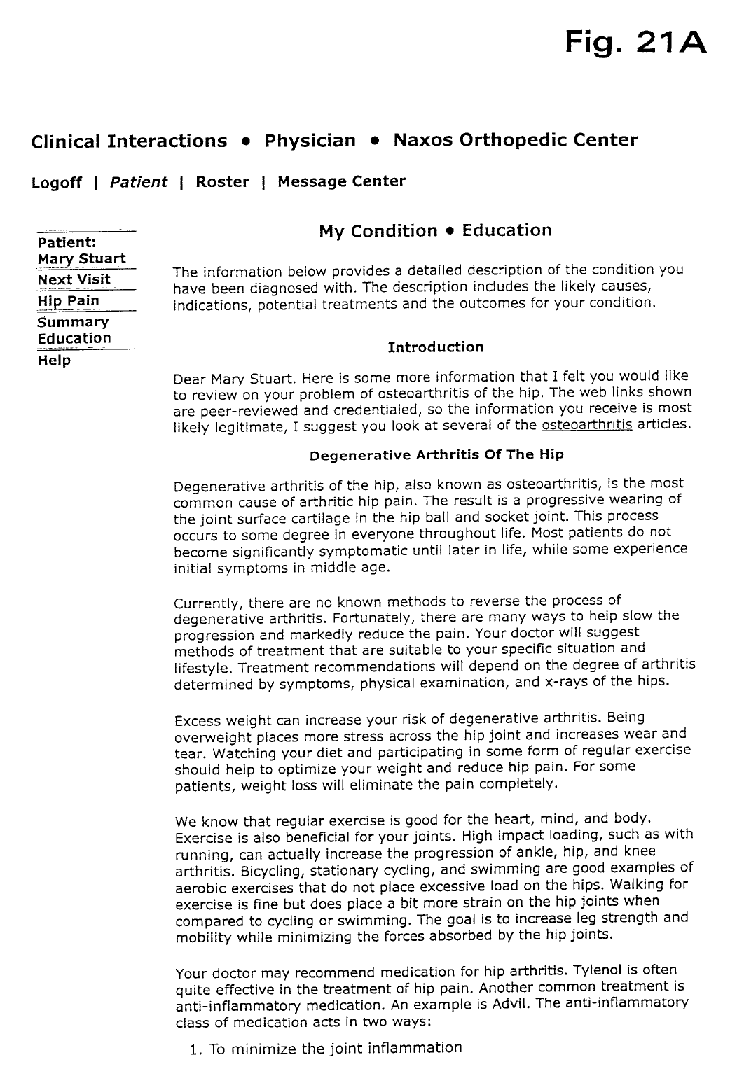

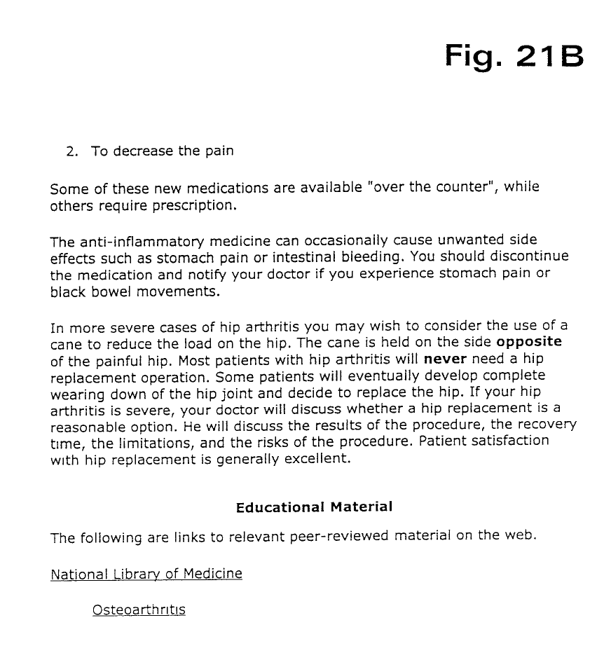

In a seventh process 67, the physician generates a post-visit report 255 that will be sent to the patient. This post-visit report may simply follow-up and confirm the diagnosis and treatment, or it may be a more detailed report that communicates a diagnosis and detailed treatment plan to the patient. An example of the physician's process to select post-visit material for a patient with knee pain is shown in FIGS. 20A to 20C, and an example of a post-visit report sent to the patient is shown in FIGS. 21A and 21B.

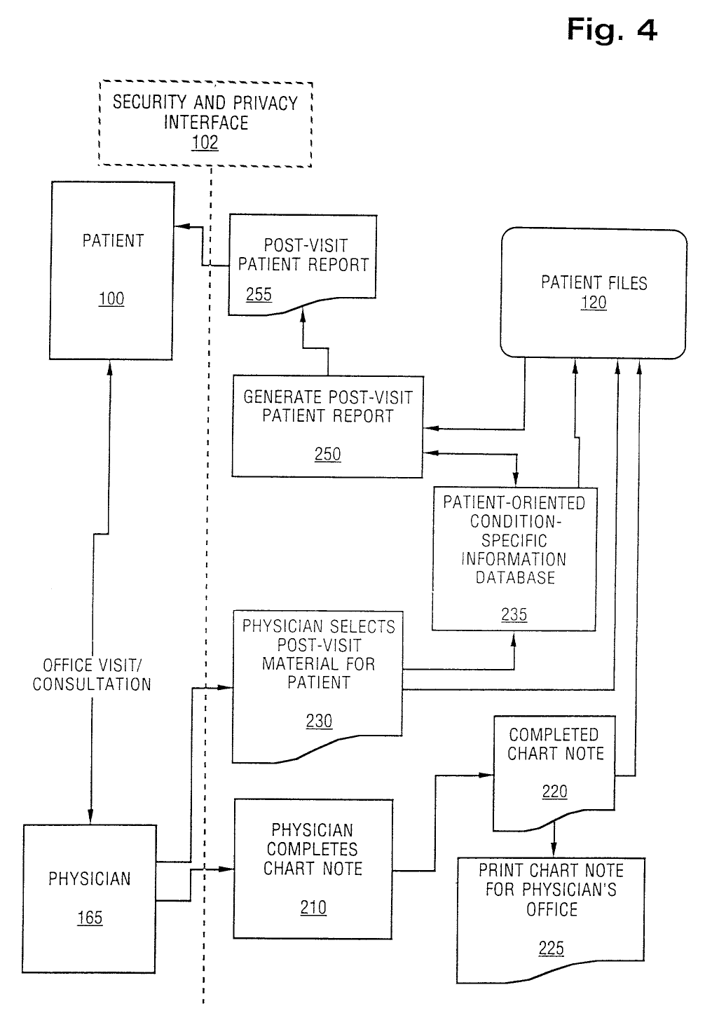

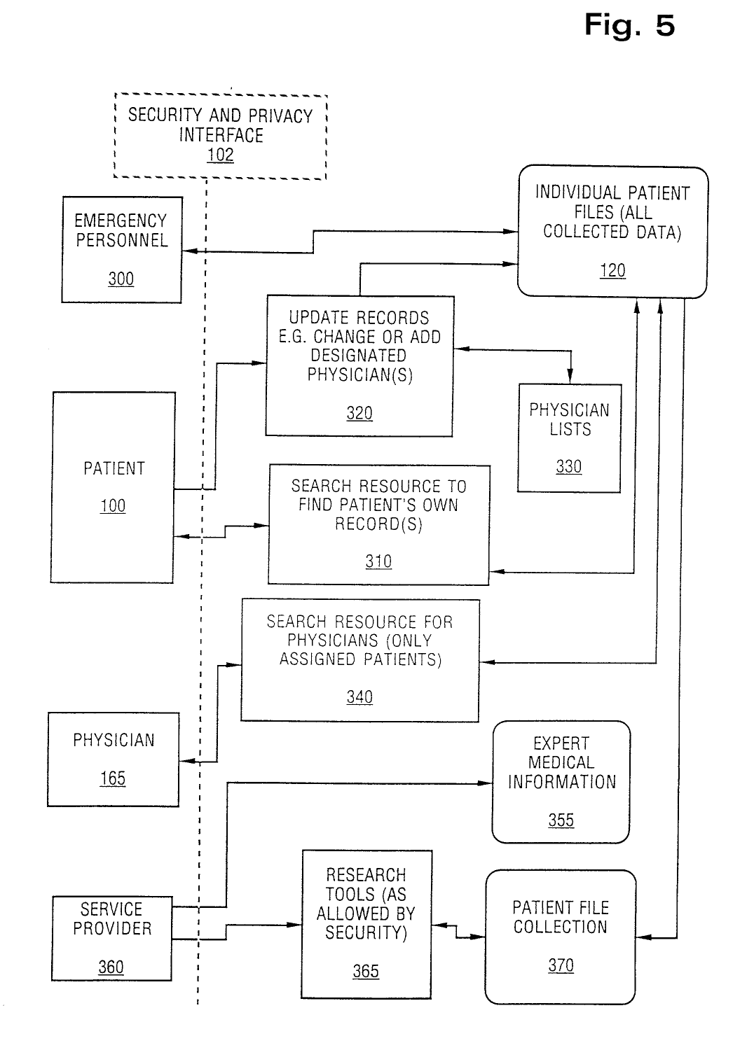

Reference is now made to FIGS. 3-5, which shows a detailed embodiment of a medical information system in a diagrammatic form that includes processes and data structures. FIG. 3 shows a configuration that includes activities in preparation for a consultation (visit) between a patient and physician. FIG. 4 shows a configuration including the office visit in which the patient consults with the physician, which typically includes a physical examination, and post-visit activities. FIG. 5 shows a configuration after the patient is now registered into the system after completing his initial interview and after meeting with the physician. It should be clear that the MI system can be implemented in a variety of configurations.

FIG. 3 is a diagram of processes and related data pertaining to preparation for a consultation (visit) between a patient and physician. FIG. 3 is applicable to new or returning patients. A patient 100 includes any living being who wants or needs to visit a physician and/or has a medical condition for which that person seeks treatment. Herein, a patient is discussed in terms of a person whose patient files are being populated and about whom the interview centers.

A security and privacy interface is indicated by a dotted line 102 that separates the patient and physician from processes performed in the server site and data stored therein. It is expected that all transactions involving personal medical information are subject to certain security and privacy measures. For example, HIPAA (Health Insurance Portability and Accountability Act) sets forth standards that protect patients' privacy of their medical records. The dotted line 102 extending downward from the box 120 indicates that MI system processes and data to the right of the dotted line are accessible only if security measures are followed by the patients, physicians, and possibly others who are represented on the left side of the dotted line 102. The security and privacy interface includes all measures taken to ensure that access to the medical information is only available to those appropriately involved in the care of the individual. The measures may include use of codes and passwords by patients, encryption of information sent over the Internet or other communications networks, limiting access to the patient's records to only those physicians selected by a patient, and other measures. This security and privacy interface applies to all transfers of information from the MI system, whether these transfers are between patient and physician, emergency personnel, or others.

As discussed herein the MI system server performs a variety of functions, including actual processing of the information as it assists the physician/patient information exchange. Some of the MI system server site processes, which are typically performed by software, are contained within the box 105, including an intake/interactive interview process 115, a process 130 to generate a pre-visit summary for the patient, a process 150 to generate condition-specific material for the physician, and a process 170 to build a preliminary chart note. The MI system server site may also assist in the functions of the security and privacy interface as described elsewhere herein.

The intake/interview process is shown at 115, which includes functions performed in the web-based interview of the patient by the MI system on behalf of the physician and physician's office. This interview can be conducted in a variety of ways, including using an electronic communication network such as the Internet, subject to the appropriate security constraints. For example, the patient logs on to the MI system site and then the interview is presented on the patient's browser through a series of selected web pages. In one implementation of this interview, the patient is presented with a number of web pages, each covering specific areas of information needed for the creation of the office medical chart. The patient fills out all these pages if it is the patient's first interaction with the MI system site. If the patient is being interviewed for a follow-up visit, the patient may simply review most of the information to verify it is correct, and then provide additional information to update the patient's current condition and address any medical concerns that the patient may have. In one embodiment, the patient first contacts the physician's office which provides the patient with access information. The physician's office then logs onto the MI system site, enables the patient's access to the MI site, and also enables certain conditions.

In the intake/interview process 115, the pages presented to the patient may cover a wide variety of areas, such as:

i) Patient demographics, typically including routine information about the individual that helps identify the patient such as date of birth, address, phone numbers, next of kin, emergency contact procedures, and so forth.

ii) Insurance information—this page collects the insurance policy information needed for various office functions such as visit authorizations and billing.

iii) Past medical history—this page collects the patient's medical history outside of the specific history for the current office visit. This information directly populates the “past medical history” section of the office note. One standard past medical history includes allergies, medications, past medical illnesses, previous surgeries, family history, and social history.

iv) Review of systems—this page collects a standard symptom review of the various body systems for the individual patient and will be used to populate the “review of systems” section in the office note that will be supplied to the physician selected by the patient.

v) Health status survey or other outcome measures—this page collects patient level self-assessed outcomes. One example of an initial outcome measure is a “Short Form 12” standard health status survey.

vi) Condition-specific interview—this page conducts the condition-specific interview(s) of the patient. The page is determined by the condition(s) for which the patient is coming to the office. The term “condition” is used herein as a general term to represent any illness, disease, injury, procedure, condition, or health maintenance visit. In one condition-specific interview, the appropriate condition-specific interview page(s) are selected from the web page interview database 125, based upon the conditions enabled by the physician's office. The information gathered in the condition-specific interview will be used to populate the “history of present illness” section in the medical office's chart note that will be provided to the physician. The service provider of the MI system site utilizes a number of experts (content physicians) who create and maintain the condition-specific interviews that appear on the web page(s).

Patient files, shown at 120, represent the information that is collected from each patient and is unique to that patient. The patient records may be implemented in a variety of configurations; for example the file may be defined by a group of related databases. This file is useful to effectively transfer information between the physicians and patients. For example: i) this material is selectively used to populate the medical chart note, ii) this material provides the demographic information and insurance information for the patient's record at the physician's office, and 3) this file is the repository of the patient's information including both the information supplied by the patient and that sent to the patient by the physician.

The patient's file is kept in a secure environment in the MI system site, and is subject to security restrictions. For example, it may be accessible only to the patient, those assigned by the patient to render care (e.g. physicians assigned by the patient), and in some limited instances, it may be accessible by emergency personnel. Subject to conditions that guarantee security and privacy of the patient records, the clinical contents of the file may be available for searching by selected physicians, such as those selected by service providers of the MI system site. For example the clinical contents may be made available without any patient identifiers to meet privacy concerns.

At 125, the database of web pages for the patient interview are shown. The interview page database 125 includes multiple web pages that will be used to interview the patient. These web pages each conduct a segment of an interview based upon personal characteristics, such as the age and gender of the patient. For example, for each condition, at least one separate web page may be used. Additional pages may be used for follow-up questions.

For example, the web pages may be used to present the following interviews of the patient: i) patient demographics, ii) insurance information, iii) past medical history, iv) review of systems, v) health status survey or other outcome survey, and vi) condition-specific interview.

At 130, the pre-visit patient summary 145 is generated for the patient 100. The generation process 130 includes the server process of assembling the condition-specific information that is supplied to the patient immediately after completion of the interview but before the office visit. This information is referred to herein as the “pre-visit” summary and includes a text summary prepared by MI system content physicians and a set of “key” questions that are appropriate for the patient to ask the physician at the time of the visit.

The pre-visit summary is derived from three main sources: i) the patient file 120, ii) the pre-visit summary text database 135, and iii) the pre-visit key question database 140.

In one implementation, the process that generates the pre-visit summary follows these steps: 1) the basic pre-visit text summary is chosen by patient age, 2) the pre-visit summary may by personalized in response to feedback from the patient file 120 and condition-specific information, 3) several basic key questions are selected by patient age. Further questions are triggered by specific patient responses during the interview. These questions are in the database but only added to the set sent to the patient based on specific responses now in the patient file. An example would be if a patient were being seen for ankle pain and had reported that he weighed 300 pounds. An added question is triggered by the patient's weight—“Is my weight a concern with this ankle pain?”

After it has been generated in the process 130, the pre-visit summary 145 is placed in the patient's file and is available immediately for viewing by the patient. To the extent permitted by security constraints, the pre-visit patient summary (or notification of its availability) could also be sent to the patient by, for example, e-mail or fax.

A pre-visit summary text database is shown at 135. The pre-visit summary text database 135 is the collection of condition-specific responses given to the patient upon completion of the interview. This information is created and maintained by MI system content physicians. This is educational material intended for used by patients, and typically does not offer any treatment advice. It may be accompanied by one explanation of its intent, which is to prepare a patient for a visit with a physician.

At 140, a pre-visit key question database is shown. The pre-visit key question database is a collection of condition-specific questions from which certain questions are selected that are given to the patient in the pre-visit summary at the completion of the interview. These questions are designed to help guide the visit with the physician and address areas that the physician is likely to inquire about, based upon the patient's condition(s). In one implementation, these questions are constructed with the intent of focusing the office visit on the important issues about the management of the specific condition. The questions are selected for the particular patient during the process of generating the pre-visit summary 130. For a specific condition, these questions may vary dependent upon age, gender and other input from the patient's file.

At 150, a process is shown to generate condition-specific material for the physician, which is provided to the physician in a pre-visit report. This process 150 is a server process by which the condition-specific material is assembled for the physician.

This material is assembled from the physician-oriented condition-specific database 155 and the patient file (120) and includes, for example: i) literature references, ii) work-up algorithms; iii) treatment guidelines, iv) suggested web links, and v) the pre-visit key questions supplied to the patient. This material is made available for review by the physician via a suitable system such as the physician's browser that is connected to the MI system server, subject to the appropriate security constraints. The physician's browser is used to present the information on the condition for which the patient is being seen. During the examination process, the physician may select another condition as the diagnosis becomes apparent and then the information on this new condition can be shown. At the physician's option, the physician may utilize resources on the MI system site, and independently search for any material in the system, on any condition.

In one example, the process 150 for generating the physician-oriented condition-specific report 160 includes the following steps:

1) The condition is identified from the patient's file as the reason for the visit (chief complaint).

2) The physician-oriented, condition-specific database 155 is organized by condition, and the material under this condition is made available by a link that appears on the browser.

3) The patient's chart note appears first on the physician's browser, the physician is given the option to select a link such as “MD educational material” and upon selection of this link, a page appears with this material.

4) If the physician changes the diagnosis, he may select physician-specific material relevant to the new diagnosis.

At 155, a database for storing physician-oriented condition-specific material is shown. The database 155 contains condition-specific material intended for use by physicians. This material is organized by condition and is selected by the content physicians and updated regularly. The material included in the database 155 includes, for example: i) literature references (abstracts when available), ii) work up algorithms (e.g. branching trees), iii) treatment guidelines, iv) suggested web links, and v) other written sources by condition.

At 160, a pre-visit report is shown that includes condition-specific material for the physician. The report 160 is the result of assembly of the condition-specific information for the physician. This report 160 is supplied over an electronic communication network, and in one embodiment presented on the physician's browser. The material for one embodiment of the report 160 is described with reference to the 150, which describes the process of generation of the report.

A physician and front office, shown at 165, represents the physician's practice, including the physician and support staff. The front office personnel, such as the receptionists and business employees have different informational needs than the clinicians seeing the patient. The front office needs the patient demographics and insurance information, but does not directly need the clinical material. The physician is mostly interested in the clinical material, but may also want to review the demographics and insurance information. In some instances, the division of labor between the physician and front office coincides with the privacy issue of electronic healthcare information. The front office personnel do not routinely need the clinical information in order to assemble the patients chart and do the appropriate billing. Occasionally the business staff does need to review the record for coding and therefore with an audit trail, this information would be available. In routine use, the information will be in print form in the patient's chart note that can be accessed by these individuals in the front office based on need. Access to the actual clinical material is needed by the physician, nurses or physician's assistants who are working with the patient, and the medical transcriptionist.

At 170, a process of building a preliminary chart note is described. The chart note building process 170 is the server process that constructs the chart note, to the extent of the information available in the patient's file. The information collected from the patient during the general and condition-specific interview is organized into medical records format. This material comes from the patient file 120 and is organized to the format from the chart note database 175. The preliminary chart note is provided to the physician/front office in an editable format so that the physician/front office can edit the information therein. In one embodiment, the preliminary chart note is supplied in a web page with editable text boxes; in other embodiments another editable format, such as Microsoft Word®, may be used for the preliminary chart note.

The elements of the chart note gathered from the web-based interviews include, for example: i) chief complaint(s), ii) history of present illness, iii) past medical history, including allergies, medications, medical illnesses, previous surgery, family history, and social history, iv) review of systems, and v) health status survey.

To assist in the chart building process 170, the preliminary chart note includes editable text boxes into which text many be inserted. These editable text boxes are added selectively throughout the chart note to allow transcription into the note. In other words, the text boxes appear as items in the chart note, and are completed by the physician based upon examination of the patient. The text boxes include sections such as the physical exam results, assessment, and plan of care that are added to complete the chart note. The text boxes allow the physician or an assistant to directly type in (or dictate) the relevant information, such as diagnosis and conclusions.

At 175, a chart note database is shown, which is the database that includes a collection of chart note formats available for use by the server process 170 that builds the preliminary chart note.

At 180, a preliminary chart note is shown, which is the presentation generated by the server process 170 that builds the preliminary chart note. The information in the preliminary chart note is typically sent over an electronic communication network (subject of course to the appropriate security constraints) and shown on the physician's browser. The information on the preliminary chart note includes information such as demographics and insurance information available for the front office, and clinical information for the physician.

The preliminary chart note includes the items gathered from the web-based interview of the patient, such as: i) chief complaint(s), ii) history of present illness(es), iii) past medical history including allergies, medications, medical illnesses, previous surgery, family history, and social history, iv) review of systems, and v) health status survey. Text boxes are provided selectively throughout the chart note to allow transcription into the note. These text boxes are items in the chart note that are determined by the physician such as the physical exam, assessment, and plan of care that must be added to complete the note. The text boxes allow the physician or an assistant to directly type in (or dictate) the relevant information, such as diagnosis and conclusions.

Reference is now made to FIG. 4, which is a diagram of processes and related data pertaining to a consultation (visit) between a patient and physician, and the final report.

At 210, a process is shown in which the physician completes the chart note based upon the patient's visit. For example, the physician's browser can be used to complete the chart note supplied (or saved) therein. Completion can be accomplished in a number of ways, such as: i) typing the need information into the text boxes provided in the chart note, ii) dictating on a tape the material that needs to be added, and then utilizing a transcriptionist to type the physician's dictations into the text boxes, and iii) using voice recognition software to allow the chart note to be completed on the browser screen nearly instantly while the physician dictates. It is anticipated that physicians will often dictate and then have a transcriptionist complete the note.

At 220, a completed chart note is shown, which represents the result of the physician's efforts to complete the chart note. The completed chart note can now be printed for the physician's office medical chart 225 and sent electronically to the MI system for storage in the patient's file 120. Sending of completed chart note to the MI system site may trigger generation of the post-visit report 250.

At 225, a printed chart note is shown, which is the chart note printed for the physician's office file and other uses as desired.

At 230, a process is shown in which the physician selects post-visit material for patient. In addition to completing the chart note, the physician can select educational material for the patient to review and study. This box 230 represents the physician selecting educational material for the patient from a patient-oriented condition-specific information database 235 in the MI system site. In one implementation, the physician selects a reference by enabling a link in the user's file to the selected reference.

The material in the post-visit report can include a variety of types of information, such as: i) post-visit condition-specific summaries written by the MI system content physicians (stored in the patient-oriented condition-specific database 235) that are appropriate for the patient, ii) appropriate literature references (from database 235), iii) suggested web sites (from database 235); and iv) the patient's health status report (from the patient's file 120). It may be noted that much of this material supplied to the patient in the post-visit report is contained in a patient-oriented condition-specific database (235) that is appropriate for a patient rather than a physician/expert.

Selection of the post-visit material can be accomplished in a number of ways. For example, after receiving the completed chart note, the MI system can ask the physician to select post-visit material to be made available to the patient. In one example, 1) the physician selects these items from a menu on a web page that he calls up while viewing the patient's information, 2) the physician clicks on each available item that he wishes to be sent to the patient, and 3) this material is sent to the patient's file 120.

Once the report is available, in the patient's file the selected material is flagged (enabled) for retrieval by the patient.

At 235, the patient-oriented condition-specific database is shown, which is a collection of educational material organized by condition that is available for the treating physician to send to patients. The information in the database 235 is typically appropriate for patients rather than physicians. To assist the physicians in making an appropriate selection, the general technical level of the material (e.g. basic, advanced) may be indicated.

This database contains material such as post-visit condition-specific summaries written by the MI system content physicians, appropriate literature references, and suggested web sites. The material may be presented to the physician on his browser as noted for 230.

At 250, a process is shown to generate a post-visit report to a patient. The process 250 is a server process that represents the activities associated with generating the post-visit report after the physician has completed the chart note and selected the post-visit material. In this process 250, pertinent information is selected from the patient's file and this information is then included in the post-visit report for the patient to view. The material selected by the physician in 230 is sent to the patient's file 120 and is accessible by the patient.

At 255, the post-visit patient report is shown. The post-visit patient report 255 represents the actual retrieval of the report from the patient's file in a format appropriate for the patient to read and/or print.

FIG. 5 is a data flow diagram of processes relating to data access to patient's files, and also showing search resources available to physicians and patients. In FIG. 5, emergency personnel are shown at 300. Using an emergency access number, emergency personnel 300 will be able to access the patient's file. The emergency access number is generated for the patient by the security and privacy function and is kept by the patient or family. It is possible that this security access number or code will be etched on a bracelet or printed on a card carried by the patient. In case of an emergency, especially with the patient confused or unconscious, the emergency personnel will be able to call up the patient's record in a format useful to the emergency situation. This information may include past history, allergies, medications, review of systems, physical exam results, problem list(s), and physician names. In order to meet security and privacy concerns, the emergency personnel may have access only to a limited part of the patient's file.

At 310, a search resource is available to find the patient's own records. The search resource 310 represents the server process that allows the patient to log on, search, and view the patient's file in the database 120. This server process is subject to security and privacy measures to necessary to protect the patient's file from improper access.

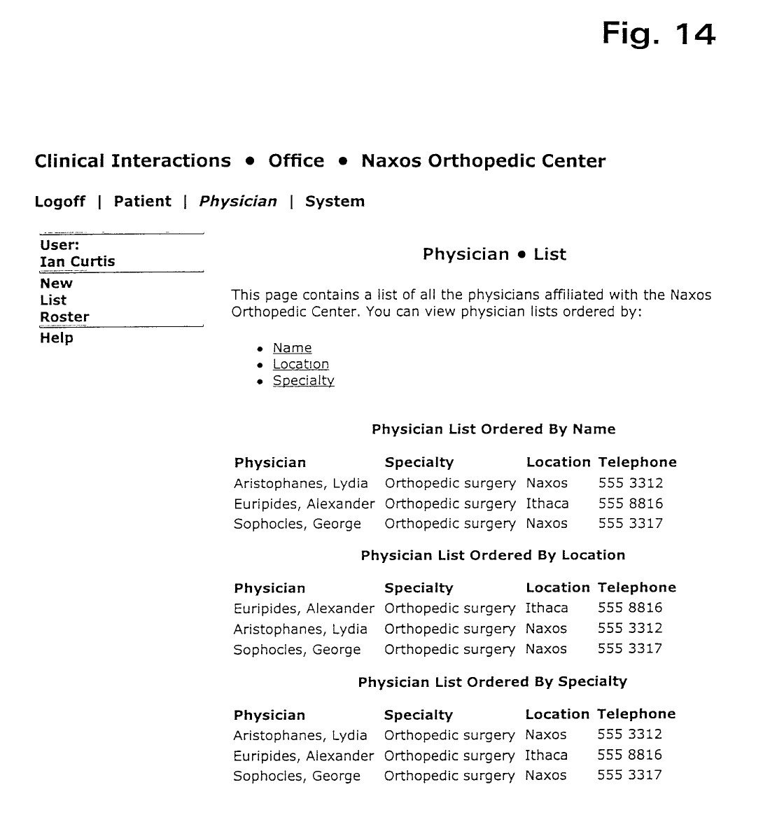

At 320, a process is available to update records by the patient. The “update records” process 320 is a server process that provides the patient's ability to update his file, such as by adding or changing the designated physician(s) who have access to the patient's file. It may be noted that the patient ultimately gives permission for another subscribing physician to have access to the file, such as in a referral to a new physician. Of course, the new physician must subscribe to the MI system in order to access the new patient's file. This server process may include a selection/search function that accesses an updated list 330 of all subscribing physicians for the patient to reference. The patient then is able to select the physician from the list 330 and grant access to the patient's file by the selected physician. An example of a physician list 330 is shown in FIG. 14, showing physicians associated with a hypothetical Naxos Orthopedic Center.

At 340, a search resource for physicians is shown. The search resource 340 is a server process that implements a search function whereby the subscribing physician can search his assigned patients for clinical problems. This allows the physician to find patients with any condition or combination of conditions. This is a useful quality tool for the physician, especially with medication updates or needs for information dissemination to patients. An example of the usefulness of the search resource 340 would be if a medication for diabetes were to be removed from the market because of side effects. The physician could search his patients for all those with diabetes and would be able to contact them. Accessing and searching the medication list in addition to the problem list, allows immediate identification of all the patients at risk. Using the search resource 340, the physician can also view the file of a specific patient for which that physician has access rights.

A service provider 360 is the entity responsible for administering and maintaining the MI system site. The service provider 360 may be any suitable entity, such as a corporation, a hospital, or a medical group.

Research tools 365 may be available in some embodiments. To the extent allowed by security and privacy concerns, the MI system service provider 360 may provide a search capability of all patient files with their identifiers removed. This search engine can be useful for a number of purposes, for example it could allow the service provider to perform studies of multiple clinical problems in credentialed patients. This information available from a search using the research tools could be useful for a variety of purposes. For example the search capability can be useful for purposes such as: i) MI system content physician studies and papers, ii) MI system content physician input into the subscribing MD educational material, and iii) MI system content physician input into the patient educational material.

In order to meet security concerns and yet make information available, a patient file collection 370 may be provided in some embodiments. The patient file collection 370 is the assembled collection of all patient files without identifiers in order to prevent disclosure of the identity of the patient(s). These patient files can be used for clinical searching and research.

Reference is now made to FIG. 6, which is a functional block diagram that shows a plurality of users connected via a plurality of communication links to an MI system site in one implementation 400. FIG. 6 illustrates that the MI system site can be utilized by a variety of users using a plurality of suitable communication links supported by the MI system site.

The MI system site 10 has been described in general with reference to FIG. 1. In FIG. 6 the MI system site implementation shown at 400 includes the capability for communicating to users over a number of different communication links. The MI system site 400 includes a communication interface including hardware, software, and other equipment that perform a variety of functions, including communicating with patients, physicians, and others over communication networks such as World Wide Web, the public switched telephone network (PSTN), or any other electronic network, or a combinations of electronic and/or optical networks. In this example, the communication interface comprises web server equipment that serves informational content to authorized users over a network using the standard protocols of the World Wide Web, communication equipment to allow access at dedicated terminals, network equipment to allow access via a LAN, and communication equipment to allow access by emergency personnel. In other embodiments, additional communication equipment may be included, and/or some may be omitted.

Computer programs 56 include those that control the functions described herein, and other programs useful for proper functioning of the site. For example, the computer programs include programs shown in FIG. 3 that 1) direct the intake/interactive interview, 2) generate the pre-visit summary for the patient, 3) generate condition-specific material for the physician, and 4) build the preliminary chart note for the physician. Generally, computer programs can be used to control any activities performed by the site described herein.

Databases 58, which are available to the computer programs 56 include patient records and other information stored by the computer programs and accessible thereby. For example, in FIG. 3 the databases include the individual patient files 120, the web pages for interview 125, the pre-visit summary text database 135, the pre-visit key questions database 140, the physician-oriented, condition-specific information database 155, and the chart note database 175.

Security and privacy procedures/systems in the MI system site 400 control access to the databases 58, the computer programs 56, and the communication link(s). A variety of security and privacy procedures/systems may be implemented, such as those necessary to meet HIPAA requirements. These procedures/systems are implemented in one or more systems including the communication server, the computer programs, and the database.

In FIG. 6, the MI system site communicates with a plurality of users via a number of different communication links. For illustration purposes, the client devices (e.g. computers, PDAs, cell phones) are not shown; only the user and the communication links used by the respective users and the MI system site are shown. Each communication link can have a variety of forms, depending upon the available communication links and choices made by the user. The following are examples of the users and types of communication links; it should be apparent that additional links may be utilized in any particular example. A first patient 441 connects to the MI system site over a first link 421 including the Internet using a phone modem 431. A second patient 442 connects to the MI system site over a second link including the Internet 422 using a wireless modem.

A third patient 443 connects with the MI system site over a direct connection 423 using a dedicated terminal 433. Such a dedicated terminal for patients may be useful, for example, if the MI system site is incorporated into medical service facility such as a hospital. Using a dedicated terminal, the patients can enter their information on-site before meeting with their physician. A physician 444 connects to the MI system site over a fourth link 424 via a LAN 434 connected directly to the MI system site, which would be useful for example if the MI system site is on-site or dedicated to the medical group with which the physician is working.

A physician's assistant 445 connects with the MI system site over a fifth link 425 including the Internet using a DSL (digital subscriber line) router. A pharmacist's office 446 connects with the MI system site over an Internet connection 426 using a LAN operated by the pharmacist's company. Emergency personnel 447 utilize a wireless modem 437 to communicate with the MI system site using a satellite link 427, in order to provide reliable communication in emergency situations.

These examples are provided to illustrate that many different users can be accommodated, communicating over many different communication links, subject of course to the necessary security and privacy constraints. It should be clear that the MI system is flexible and extensible to include a plurality of users, and that the MI system site can handle a number of simultaneous connections.

FIGS. 7-22 are examples of screen displays for many of the patient interviews and the reports for patients and physicians. It should be apparent that the content and form of these examples can vary greatly between embodiments. In these examples of screen displays, fictitious names are used for the patients and physician, the MI system site is given the hypothetical name “Clinical Interactions”, and the website has the URL: www.clinicalinterations.com.

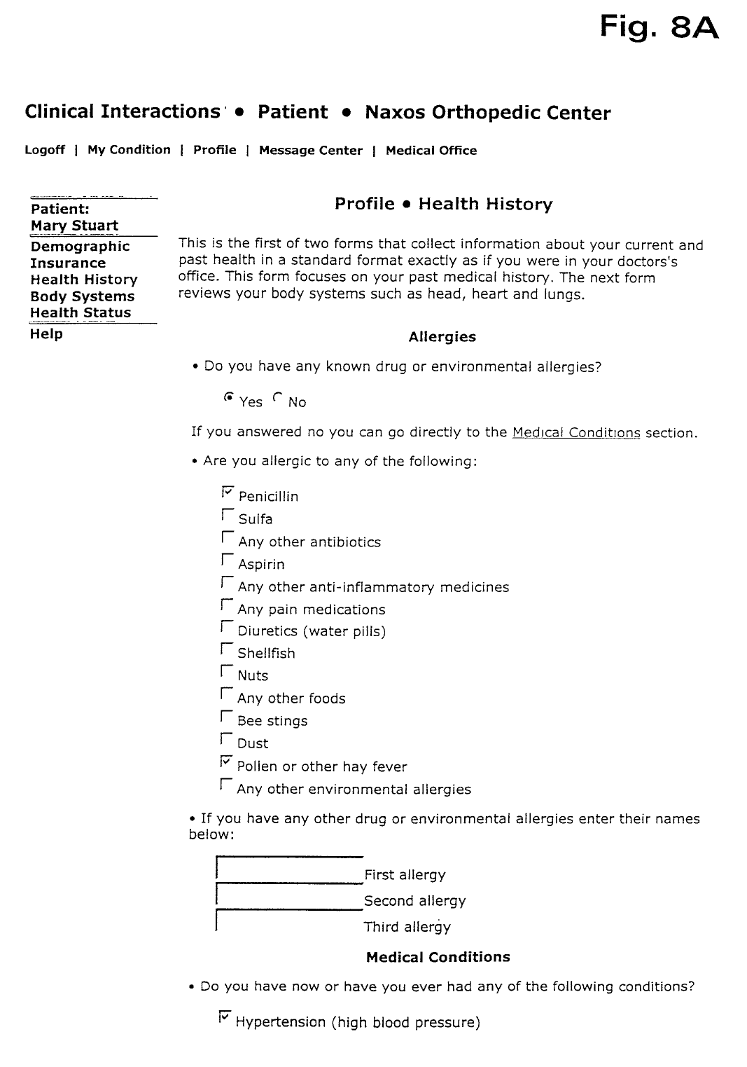

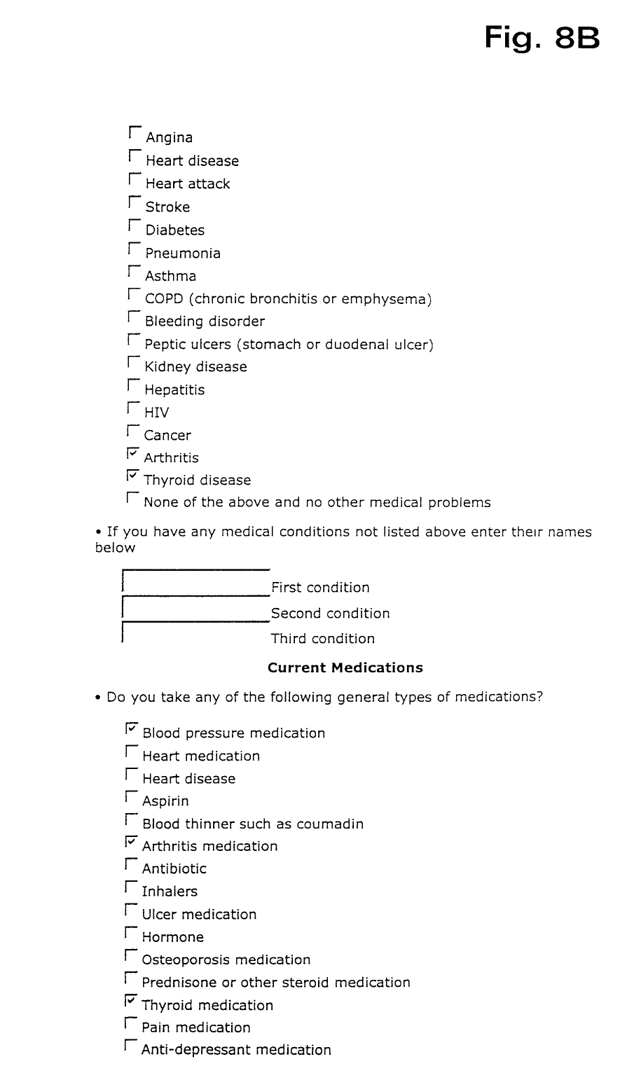

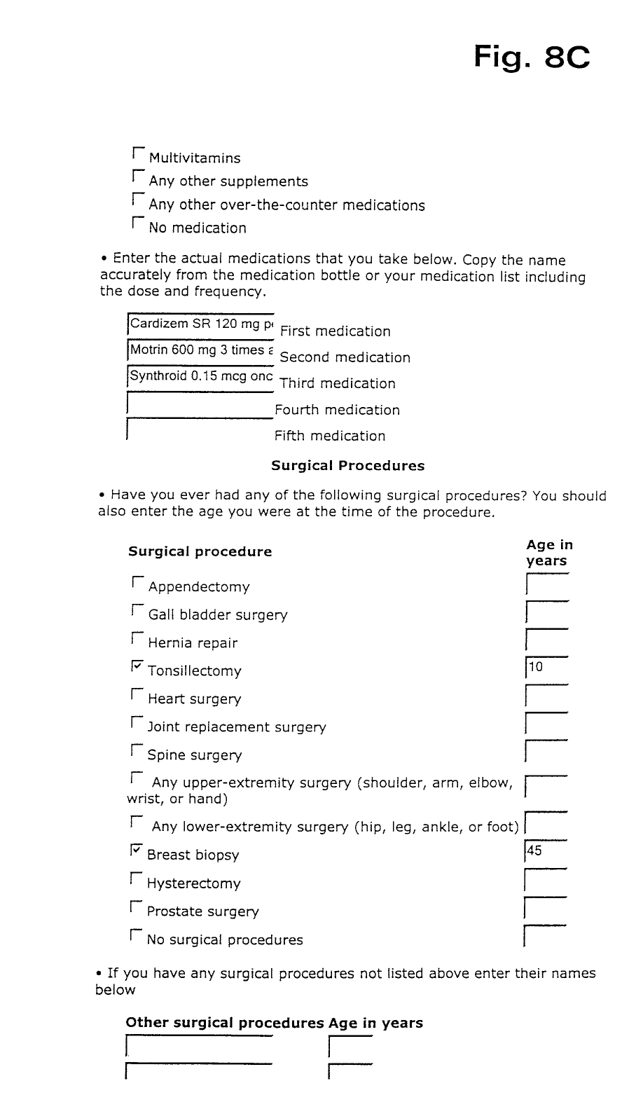

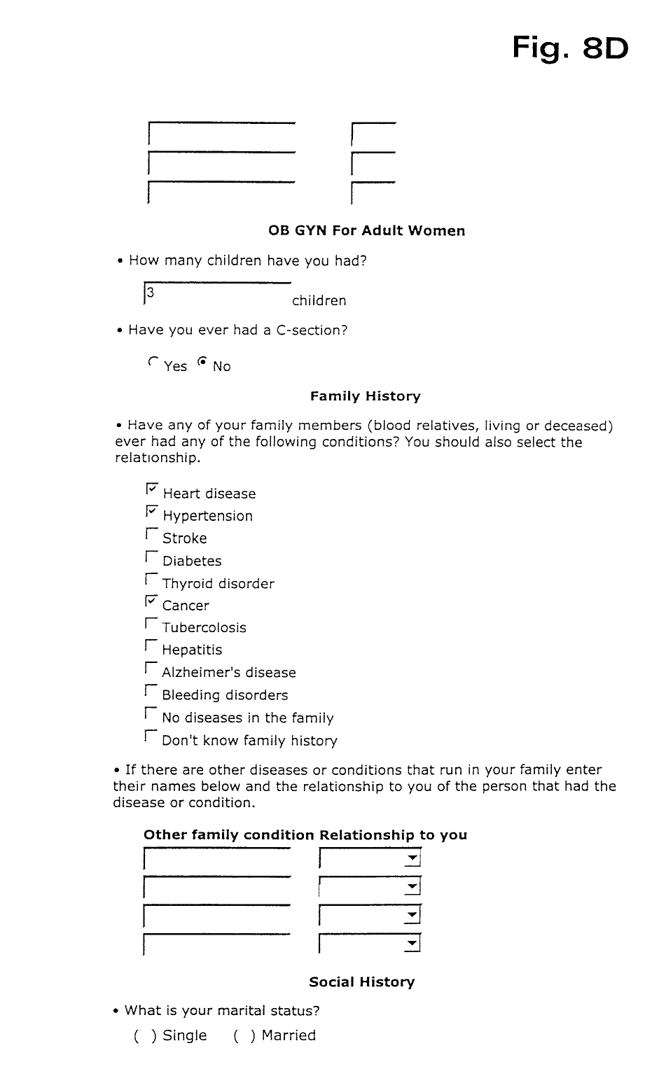

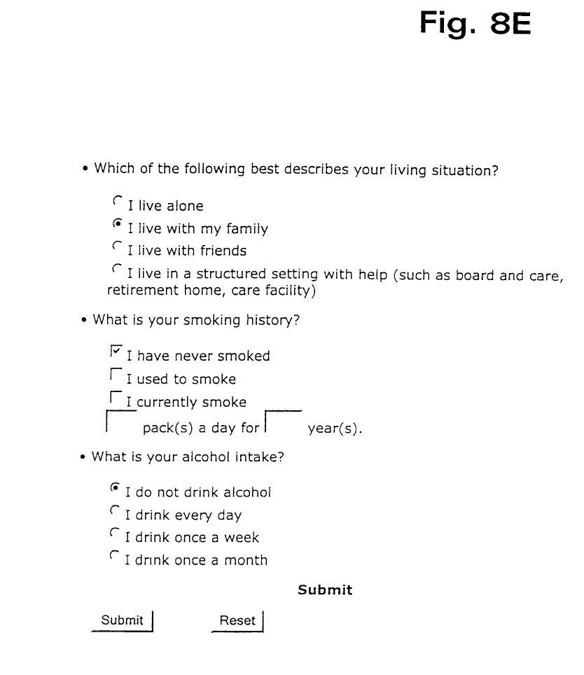

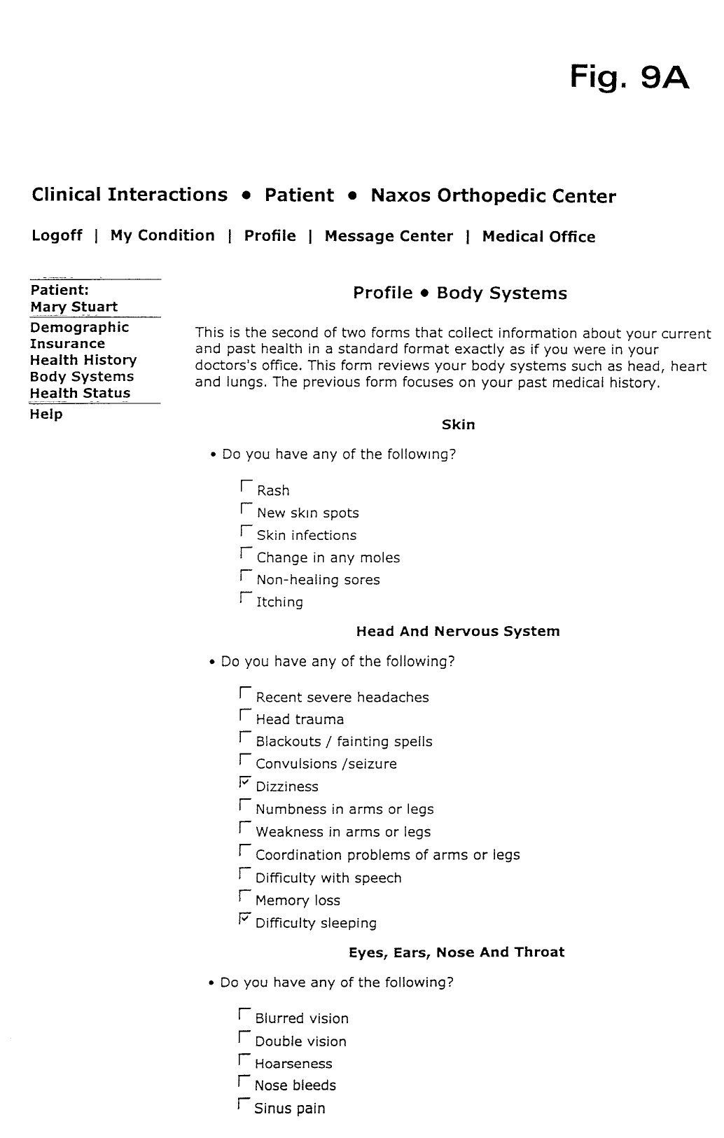

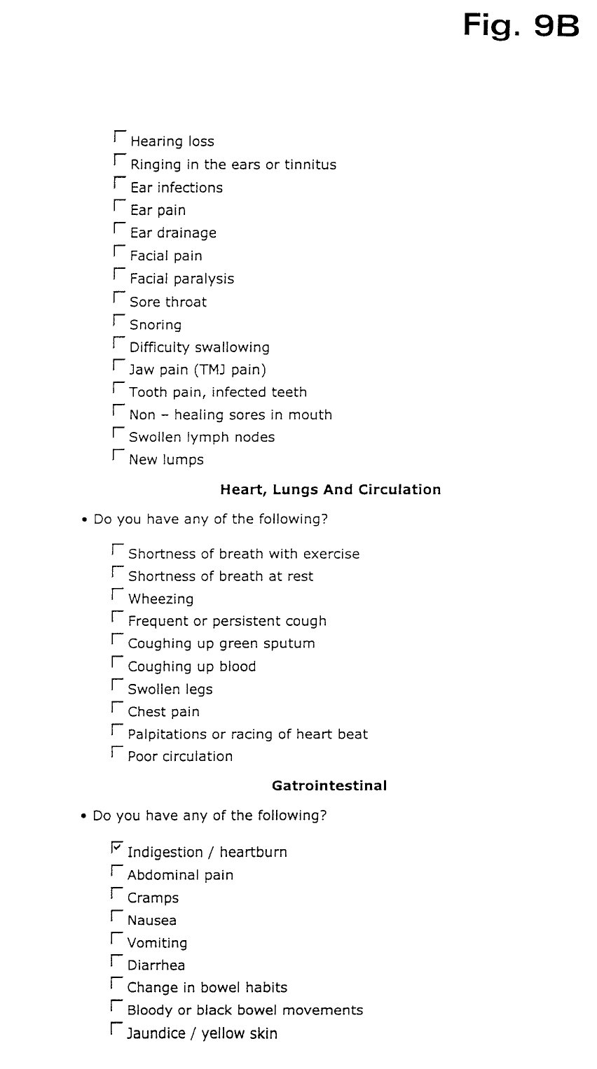

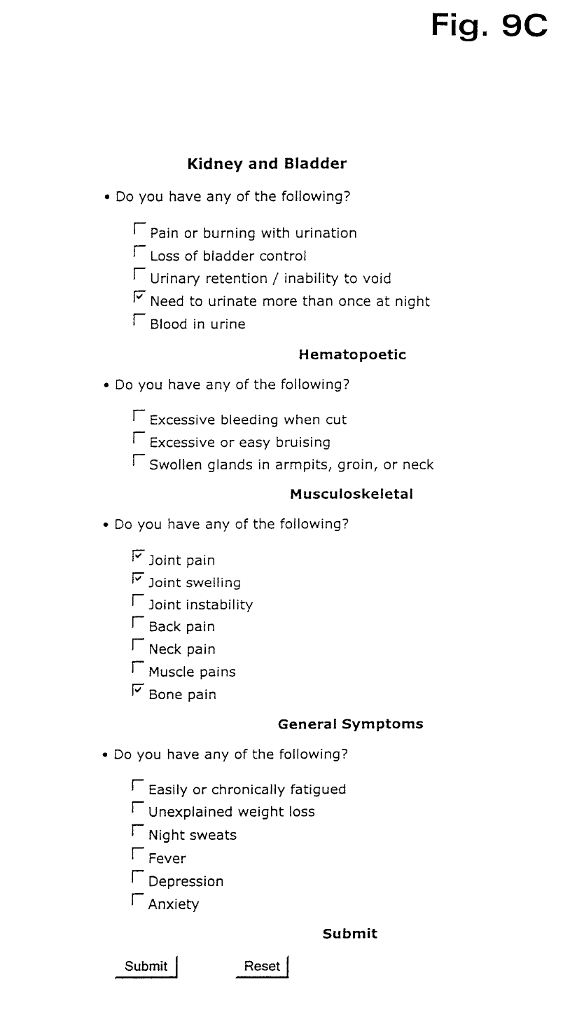

FIGS. 7A, 7B, and 7C are examples of the screen displays for a demographic interview, which is one of the general interviews. Other general interviews are shown in FIGS. 8A through 8E, which are examples of screen displays for a health history interview, and FIGS. 9A, 9B, and 9C, which are examples of screen displays for an interview regarding a patient's body systems.

FIGS. 10A through 10D are examples of screen displays for a condition-specific interview for a patient who has indications of asthma.

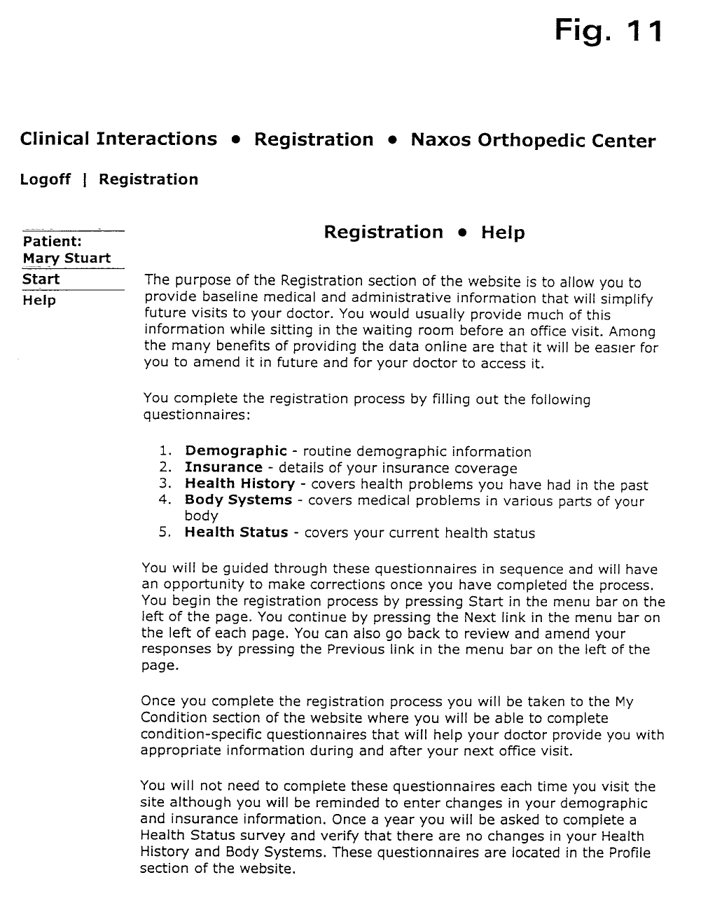

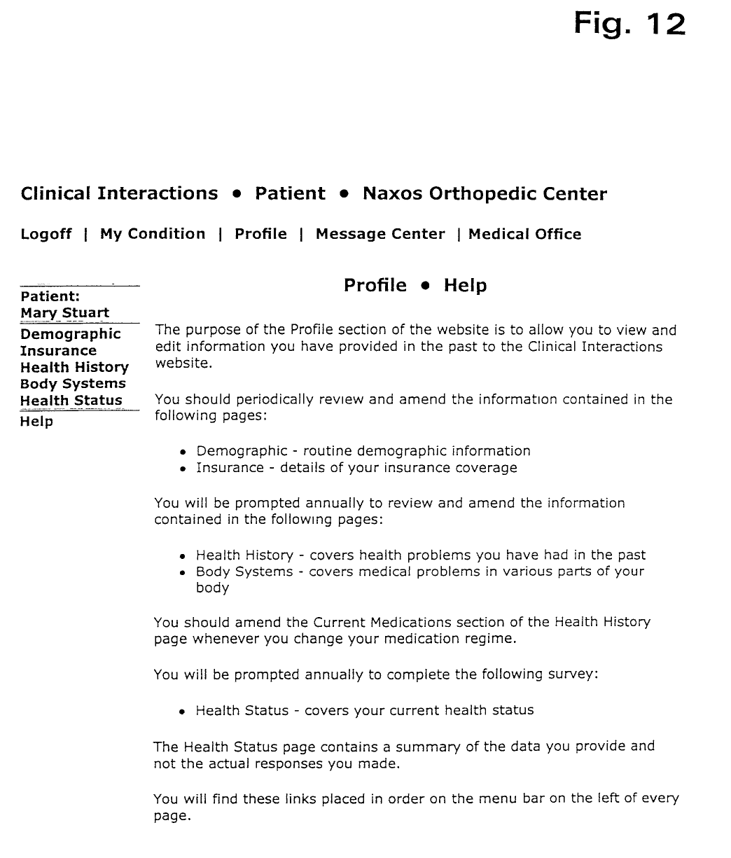

FIG. 11 is an example of a screen display that assists the patient in completing the general interviews, termed therein the Registration section. FIG. 12 is an example of a screen display that assist a patient in making changes to the patient's files, termed therein the Profile section.

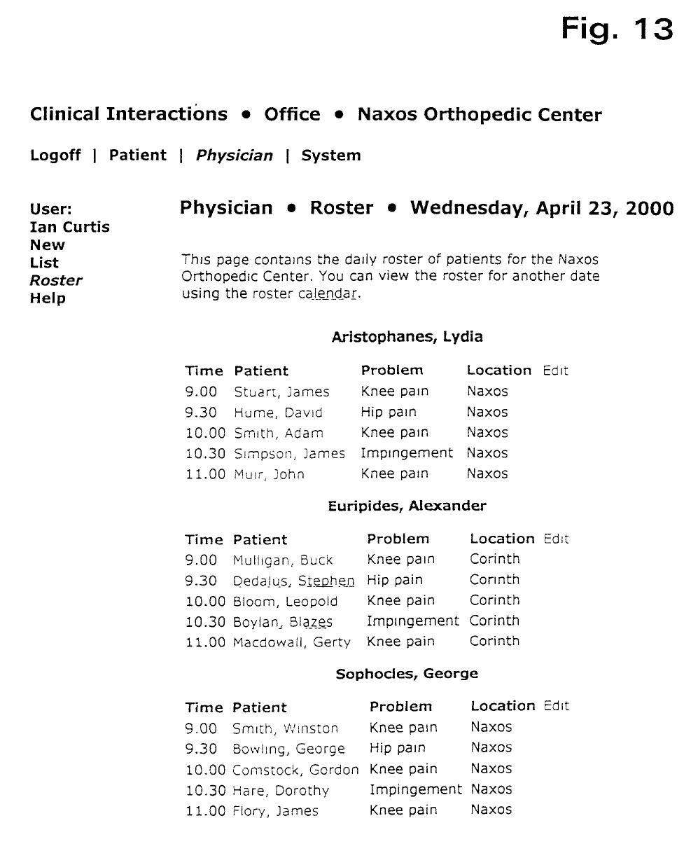

FIG. 13 is an example of a screen display for a daily roster of patient appointments for a hypothetical “Naxos Orthopedic Center” arranged in order of time, showing, by physician, each physician's patients, their problem(s), and the location of the examination. Such a roster can assist a physician in efficiently consulting with patients.

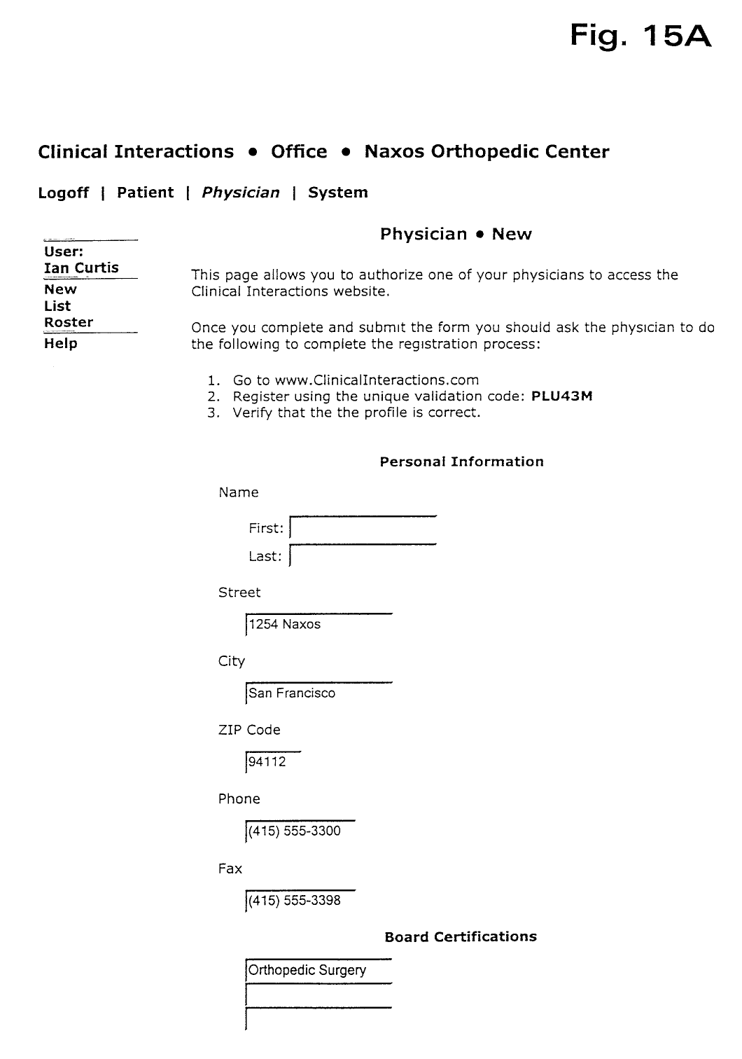

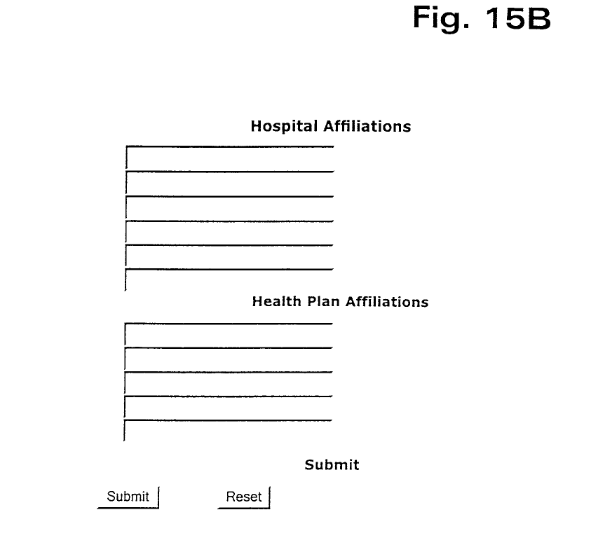

FIG. 14 is an example of screen display showing a list of physicians associated with the Naxos Orthopedic Center, including their name, specialty, location, and contact information such as their telephone number. This list of physicians can be useful for patient who wishes to designate a particular physician. FIGS. 15A and 15B are examples of screen displays used by a patient in connection with authorizing a selected physician to access a patient's medical records. Such an authorization is typically associated with a scheduled visit with the selected physician.

FIGS. 16A and 16B show an example of a pre-visit patient summary, which provides information useful in preparing for the patient's visit with the physician. The summary includes information relative to the patient's condition, including a personal summary and questions for the physician.

FIGS. 17A through 17D show an example of a pre-visit condition-specific physician report relating to hip pain, including patient information including name, date, problem, and other pertinent personal information. Also included are the questions given to the patient in the patient summary, and information useful to the physician in answering the questions. The physician also receives the patient's pre-visit summary. For the physician's use, differential diagnoses are included in the report, and also a work-up algorithm. Finally, links to additional references may be provided.

FIGS. 18A through 18C show an example of a pre-visit condition-specific physician report relating to osteoarthritis of the hip, including patient information including name, date, problem, and other pertinent personal information. Also included are the questions given to the patient in the pre-visit patient summary, and information useful to the physician in answering the questions. The physician also receives the text of patient's pre-visit summary. For the physician's use, treatment considerations are provided, and finally, links to additional references are also provided.

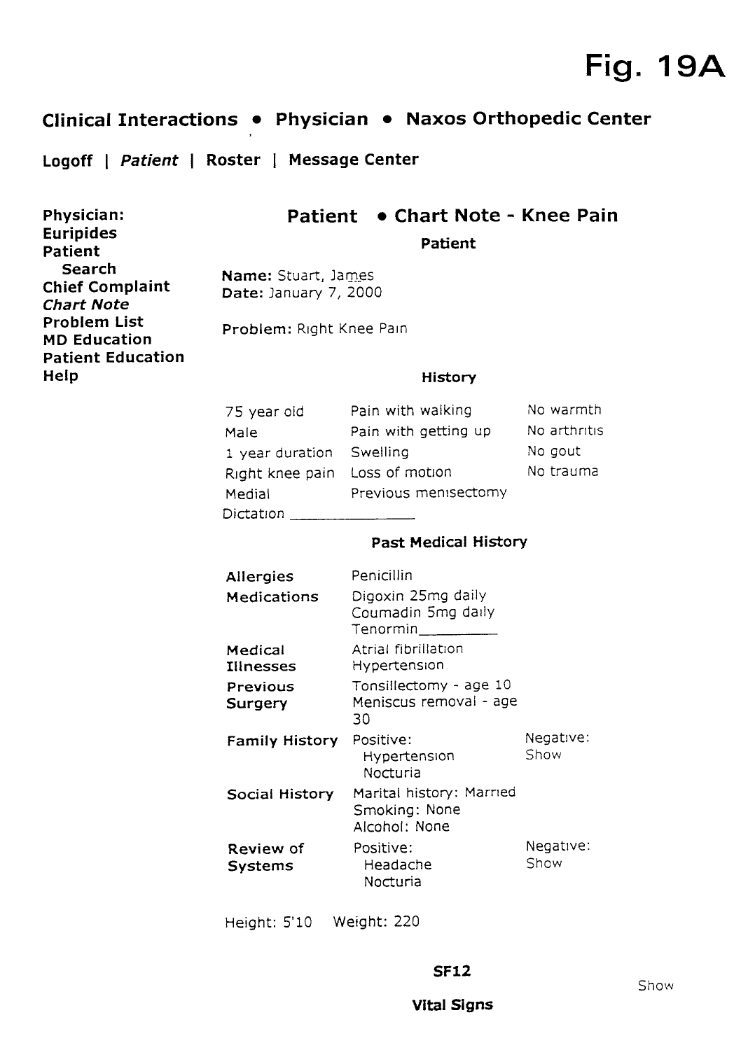

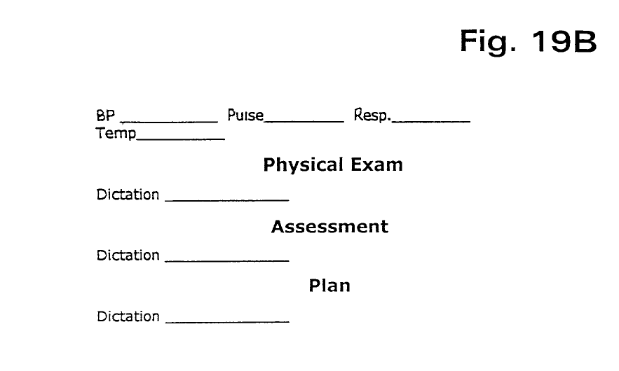

FIGS. 19A and 19B show an example of a preliminary chart note for a patient with knee pain, including general patient information, a history of the condition, past medical history, and the following sections to be completed during the examination or as a result of the examination: vital signs, physical examination observations, assessment, and treatment plan. These sections may be completed by the physician during the examination, or after the examination. The physician completes these sections by any suitable method, for example, manually (e.g. by typing), by using a medical transcriptionist, or by using voice recognition software. The chart note is typically completed by a physician's assistant.

FIGS. 20A, and 20B show an example of screen displays used by a physician to generate a post-visit patient report, allowing the physician to choose from several introductions. A proposed post-visit summary is presented to the physician for approval, and educational material is suggested. The physician indicates his approval to send the information by selecting a check box on the screen displays.

FIGS. 21A and 21B show an example of a post-visit patient report, including a detailed description of the condition the patient has been diagnosed with, and also including likely causes, indications, potential treatments, and outcomes.

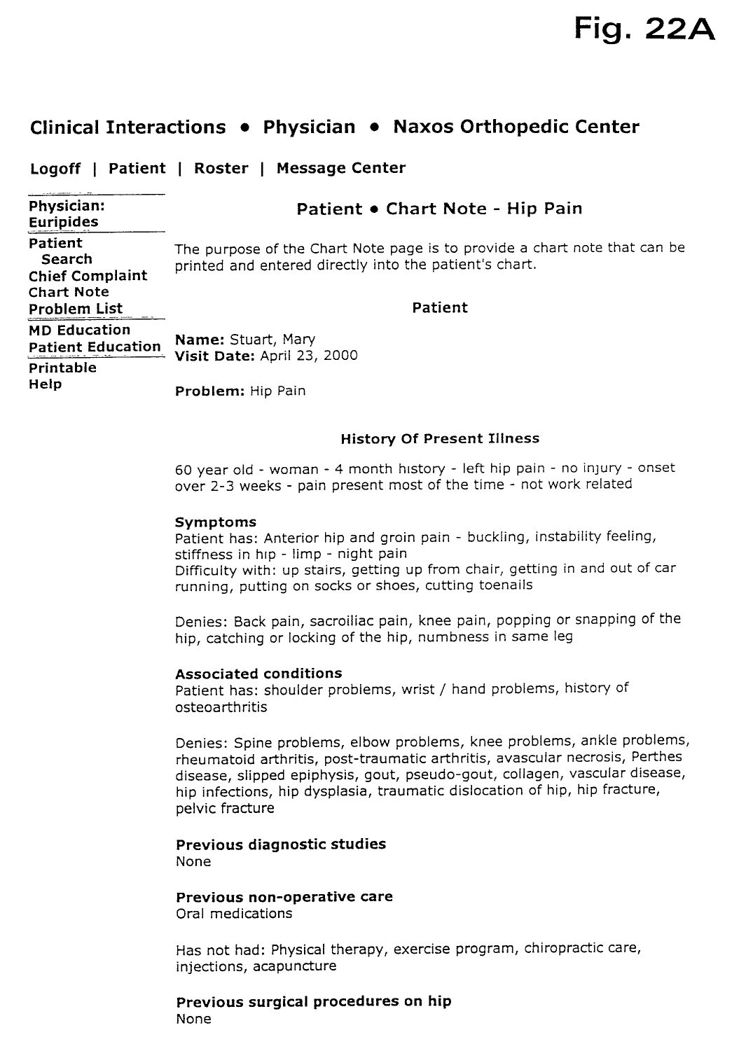

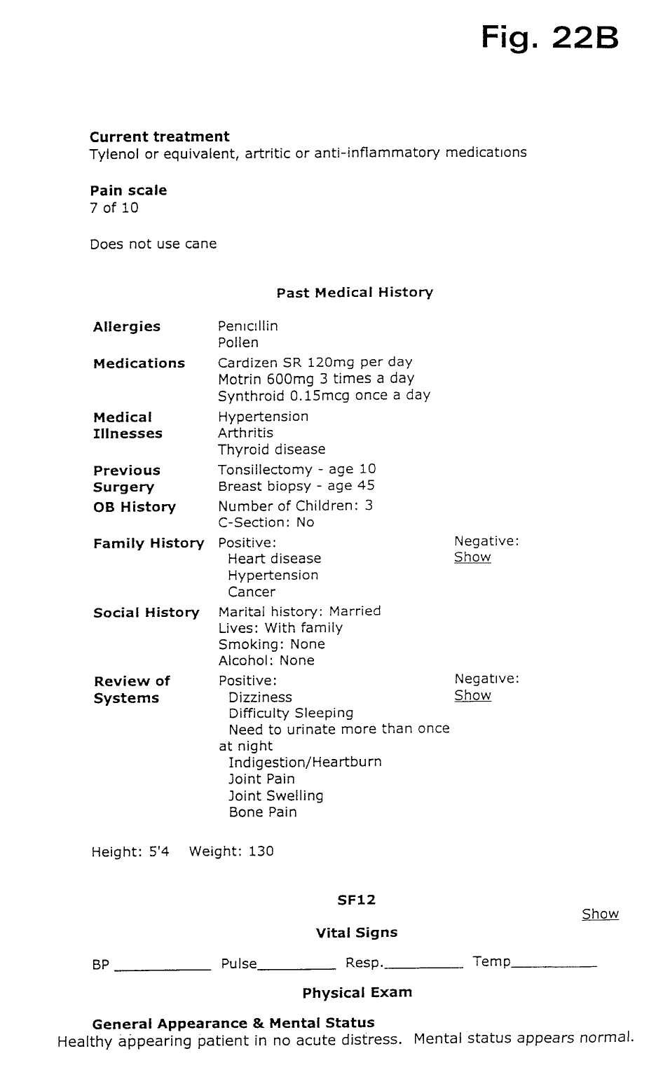

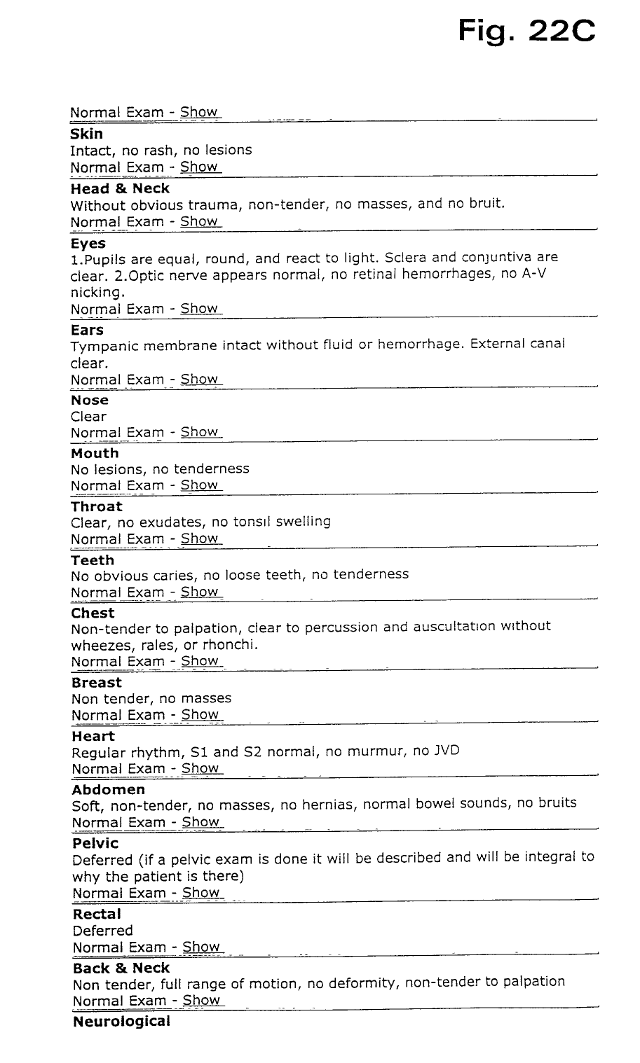

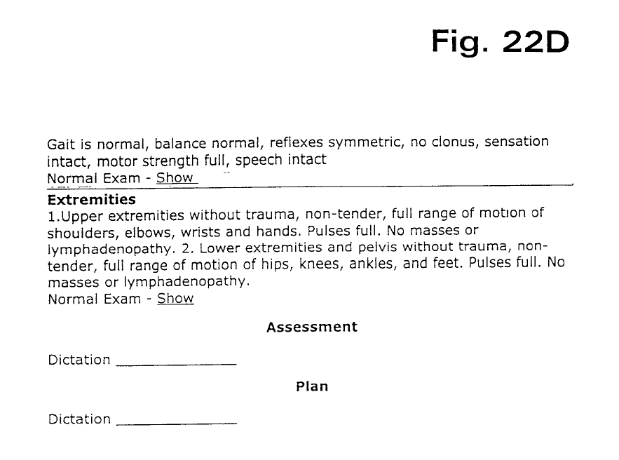

FIGS. 22A, 22B, 22C, and 22D shown an example of a partially-completed chart note for hip pain.

### Content Physicians

The MI system site provides a network-based system that assists physicians in their daily clinical care of patients. In one example, medical experts, termed herein “content physicians”, create and maintain the condition-specific medical information on the MI system. Each content physician supervises one or more conditions, the exact number depending on the complexity of the conditions and the necessary time commitment. A content physician is responsible for the informational content within the MI system regarding the supervised conditions. These conditions are within the specialty or field of interest of the content physician. The content physician also provides on-going maintenance of the supervised condition, for example to update the system regarding new medical treatments.

The condition-specific information may be created by each content physician using one or more worksheets. Typically a single content physician is able to handle only a few conditions at most. Due to the large volume of conditions that need to be addressed by a comprehensive MI system, a correspondingly large number of content physicians are utilized. The worksheets and other information from the content physician are collected and programmed into an appropriate format and implemented into the MIS site.

Condition-specific input may be gathered from the content physicians regarding informational aspects such as:

1) The condition-specific interview;

2) Pre-visit preparation for the patient;

3) Post-visit patient education, including post-visit summary and lay literature references and other links; and

4) MD education, including differential diagnoses, work up algorithms, treatment considerations (treatment algorithms), and literature references.

Described herein are examples of the informational content that is created and maintained by content physicians. It should be apparent that a wide variety of embodiments of the MI system can be created. Due to the wide variety of conditions, in any particular condition, some of these informational aspects may be irrelevant. For example, some symptom-based conditions will not need treatment considerations or a post-visit summary, as a diagnosis will be made during the visit.

### Condition-Specific Interview of the Patient

The condition-specific interview of the patient is combined with general interviews for demographics, insurance information, past medical history, review of systems, and a health status questionnaire to generate pre-visit reports regarding a new patient. Established patients with a new problem will simply take the condition-specific interview and review or update the other information. Follow-up or interim interviews for conditions may also be included.

A condition-specific interview is initiated only after the patient has been identified as possibly having the condition; for example a physician's office may enable the condition based upon a health complaint by a patient, and when the patient signs on to the MI system, then the appropriate condition-specific interview will be initiated. Typically one condition is interviewed at a time, so if a patient has two complaints, the patient will receive and complete two separate interviews.

A branching approach may be utilized in which a positive response to one question indicates another question. Using this information, a condition-specific history (history of present illness) can be obtained. Furthermore, for a specific condition, the interview may vary based upon factors such as age and gender.

This interview is designed to aid the treating physician by documenting the usual items that would be asked for any given condition; e.g. it should cover the things that a treating physician would commonly ask a patient with this complaint or condition. The treating physician, freed of much of the burden of collecting and dictating this information will have more time to go into some areas in more depth if needed.

Typically, a condition-specific interview of the patient follows these general categories of questions based upon the identified condition: 1) onset, duration and frequency, 2) symptoms (presence or absence of certain likely or co-existing symptoms), 3) associated conditions, 4) previous diagnostic procedures the patient may have had for this or related conditions, 5) previous non operative treatments the patient may have had for this condition, 6) previous operations the patient may have had for this condition or that might effect the condition, 7) current treatment for this condition, 8) any condition-specific questions the content physician feels should be asked that are not covered above. For example the interview may ask the interview to rate pain: “On a scale of 1-10 with 10 being severe and incapacitating pain, how do you rank your pain when it is at its worse?”

### Pre-Visit Preparation for the Patient; Post-Visit Patient Education

The condition-specific responses to the patient fall into three general categories. The first two categories are included in a pre-visit patient summary 145 given to the patient after completion of the interview but before the office visit. The third category is the post-visit patient report 255 which may be available after the visit at the discretion of the treating physician. The condition-specific responses are completed for each age range and gender. There are seven age ranges as defined by CPT guidelines. In any given condition several of the age ranges may not apply or may require cross-coverage with another content physician such as a pediatrician or gerontologist to complete. The standard age ranges used in one system are: infant—less than 1 year of age; early childhood—1-4 years, late childhood—5-11, adolescent—12-17, young adult—18-39, mid-age adult—40-64, senior—65 and older.

### 1.) Pre-Visit Patient Summary

The pre-visit summary is given to the patient following completion of the initial web-based interview, before the patient sees the physician. An important function of the pre-visit summary is to prepare the patient for the office visit, from the perspective that any definitive diagnosis will be made only after the patient sees the treating physician. There may be two parts to the pre-visit summary. The first part is an informative section tells the patient what to wear, what to eat, what to expect, and other information that is important or useful to tell a patient before a visit. The second part of the pre-visit summary is the key questions, discussed below and elsewhere.

Following is an example of a pre-visit summary, using the symptom “knee pain” written for the senior age group.

### EXAMPLE-Introduction

This information is to help you prepare for your visit to the doctor. You have filled out all the paper work needed for the visit and will not need to fill any more out, as the office will receive all this information. Your doctor will have all your history and medications, which should help the visit go smoothly. Your information is kept secure and is only seen by the doctor and the office staff as necessary for your care. The security and privacy of your health information is important to you and to us as explained to you during your security set up. Please remember that this information in not designed as treatment advice for you, it is designed to improve your office visit and understanding of the problem. After the summary, you will see several questions that seem reasonable to go over with your doctor.

### EXAMPLE: Personal Summary

You will be seen for knee pain which is a really a symptom and not a disease. The goal of the visit, therefore, is to determine the cause of your knee pain and to offer you some treatment advice or treatment options. After speaking with you and examining you, the doctor will discuss the reasons for the pain and any tests you might need to confirm the exact reason for the knee pain. You have helped the doctor out a great deal by answering all the questions about knee pain.

At your age there are a number of causes for knee pain, the most common being arthritis. Knee pain usually originates in the knee itself, but sometimes can occur as the result of hip or back problems or can be caused by tendons and other structures near the knee. When the cause is determined, educational material may be available for you from the doctor's office.

It is helpful if you can wear or bring shorts to the office, as this will make you more comfortable in the exam room. It is important for the doctor to be able to see your entire leg when doing the exam of your knee. It is common to need an x-ray of your knee at the time of your exam. If by chance you have already had an x-ray or other study such as an MRI of the knee, please try to bring it with you or notify the office that you have had the study.

### 2.) Pre-Visit Patient Summary: Key Questions

The “key” questions are a set of simple, guiding questions (e.g. 3-5 questions) for the patient to ask the physician at the upcoming visit. The key questions are given to the patient in the written pre-visit summary following completion of the web-based interview, before seeing the physician. These questions are designed to focus the office visit. A typical key question is simple and short, and covers informational items that the physician would usually want to cover during the office visit. The patient should feel comfortable asking the physician these questions. These key questions give the patient some direction for the visit and help the physician by keeping the visit focused. Some of these questions may be triggered by the MI system as a result of the patient's response during the web interview, but there may be a set of general questions appropriate for each age range.

These key questions are provided to the physician prior to the patient's visit; in addition the physician receives a short statement regarding the rationale for each question. The rationale behind each question is used as part of the MD education available with each patient. Examples of the MD note may be short, such as “To focus the visit,” or “This question is meant to get the patient thinking about the possible need for a test”. In some instances the MD note may be longer, for example the MD note may include a one to two sentence statement about the care or work up of this condition such as “To prepare the patient for a discussion of exercises, as a simple back strengthening program leads to improvement in 80% of people with low back pain.”

To continue with “knee pain” example above, following are exemplary questions supplied at the end of the initial interview of a 75-year-old with knee pain, with the physician comments in parentheses following the question:.

### EXAMPLE 1: Key Questions and Rationale for the Treating Physician

The following questions seem reasonable to ask your doctor about your knee pain. The answers will help you understand your exact problem and treatment.

a) Is my knee pain from arthritis or some other source? (MD note—this is meant to focus the patient on your efforts to determine the cause of the pain)

b) Is my weight a problem? (MD note: Any significant overweight condition will aggravate knee problems and weight loss for obese patients is part of any treatment regimen)

c) Should I do any specific exercises for my knee? (MD note—this is meant to get the patient thinking about doing some knee specific exercises after you determine the source of the knee pain and the exercises you feel are appropriate)

d) What general fitness exercises are OK for me to do?(MD note—this is meant to allow you to encourage aerobic fitness which is usually low impact in knee problems. Swimming and exercise bikes are usually safe bets)

e) Do I need any further tests or treatments at this time, or should we simply observe how I do? (MD note—this is meant to prepare the patient for the possibility of you ordering test or treatments)

Another example of key questions and rationale follows for the condition of hip pain, illustrating more lengthy MD notes:

### EXAMPLE: Key Questions and Rationale for Hip Pain Condition

Is my hip pain coming from arthritis in the hip? MD notes: In this age group, hip pain is often due to hip arthritis, but there are a significant number of patients with low back and other problems causing pain perceived by the patient as hip pain. The more the hip pain is felt in the groin or anterior thigh and is accompanied by a loss of range of motion, the more likely the pain is coming from the hip joint. Pain felt in the buttock and lateral hip or thigh region is somewhat less likely to be hip joint in origin and could be from other causes such as lumbar spine problems. Patients will often be surprised that what they feel as hip pain is really a back problem.

Is my hip pain coming from something other than my hip joint? MD notes: As with question 1, there is significant overlap in symptoms and making the diagnosis is sometimes difficult. Groin, anterior thigh pain and loss of hip motion along with x-ray changes are quite supportive of the hip being the problem. Buttock, lateral hip pain, neurological symptoms, and x-ray changes in the back are more suggestive of back problems. Often people have contributions from both.

Do I need any further studies such as an x-ray, blood work, or MRI scan? MD notes: This question simply prepares the patient for the possibility of a study being ordered. In this age group, plain x-rays of the hip are the most common study needed to confirm or reject a suspicion of hip arthritis. Lumbar spine films may also be an early study with any suspicion of lumbar pathology. Depending on complaints and suspicions of any other pathology, blood work, bone scans, hip aspiration, or MRI scan may all be needed. Please see work up algorithm for hip pain.

Are there exercises I should do? MD notes: For most hip problems and other problems causing pain about the hip there are exercises that should help. The set of exercises that may help will be clearer when the diagnosis is made. In addition, some form of aerobic exercise can be accomplished by nearly everyone with hip problems and should be encouraged. The exact type will also depend on the actual diagnosis.

Are there things I am doing that aggravate my hip condition and that I should change? MD notes: This question is intended to help you address any activities that the patient is doing that seem detrimental to the hip joint such as high impact sports or training. It gives the opportunity to suggest alternative aerobic activities such as swimming and exercise bike, which are often well tolerated by people with hip problems.

### 3.) PATIENT EDUCATION: Post-Visit Summary Text, Lay Literature References and Links

The post-visit summary text is a written summary (e.g. one to several paragraphs) about the specific condition, supplied to the patient at the physician's discretion subsequent to the physician's diagnosis or presumptive diagnosis. For any given patient the condition in the post-visit report may not be the same condition as discussed in the pre-visit summary, especially if the patient is being seen for a symptom. This summary text, along with other patient education material, may be made available to the patient at the discretion of the physician.

The post-visit summary text includes a lay-oriented education about the condition. After the office visit, the physician has now confirmed the condition and this summary is given to the patient at the physician's discretion. The post-visit summary can be printed at the office and/or sent to the patient's file for retrieval and printing by the patient at home. The post-visit summary text should be viewed as an educational summary for the patient, realizing that other material identified as helpful for the patient (such as lay articles or good web sites) will also be made available. In one example, the equivalent of a shopping cart is provided on the physician's browser, to which the physician adds this summary and any other material available for the patient. The summary is then available for the patient for review or print from his file. Simple exercise instructions if appropriate for the condition are included in this summary, but may be added at a later time if desired.

If the condition is a symptom, this post-visit summary may not be necessary or useful. The treating physician will make a more definitive diagnosis and use the post-visit summary from that condition for the patient. There are, however, a number of symptoms that patients carry as diagnoses for a long period of time. If the condition is a symptom but in this category a post-visit summary may be useful. Such an example would be for “back pain” or “headache” where the physician has ruled out bad things such as tumors, but still carries the patient as having back pain or headache. A post-visit summary in such an example may include text such as: “There are many reasons for this condition and you do not seen to have any of the signs of a more serious problem. This symptom is usually treated with a period of observation and some simple exercises . . . ”

An example of a condition-specific post-visit summary is shown below, for a patient diagnosed with “iliotibial band friction syndrome” as the reason for a patient's knee pain.

### EXAMPLE: Post-Visit Summary

### Iliotibial Band Friction Syndrome: A Common Source of Lateral Knee Pain

This summary is about a common and easily managed cause of knee pain referred to as the “iliotibial band friction syndrome” or ITBFS, which is diagnosed by physical examination without the need of special tests. Simple stretching exercises are usually successful in alleviating the pain.

The iliotibial band is the firm tissue felt on outside of the thigh. It is the extension of muscles originating on the pelvis and crosses the outside of the knee to insert on the tibia. With movement of the knee the iliotibial band moves across the prominence of the distal femur (the epicondyle). If the iliotibial band is tight, this movement can cause a rubbing or friction against the femur that becomes painful.

Runners are particularly prone to this problem for three main reasons. The proximal muscles which make up the origin of the iliotibial band become stronger and therefore tighter with training, runners often don't think or know how to stretch the iliotibial band, and running exposes the lateral femur to multiple cycles of the tight iliotibial band. ITBFS is essentially one of the overuse injuries seen in runners.

Burning or stinging pain on the lateral side (outside) of the knee is the most common symptom and usually occurs at heel strike. There is usually a tender area on the lateral side of the knee about an inch above the joint line at the prominence of the femoral epicondyle.

Treatment is a simple set of stretching exercises that the patient performs daily. If ITBFS seems to be the cause of a runner's lateral knee pain it is appropriate to do the stretching program and observe the results before embarking on any further expensive or invasive work up.

Training can usually be continued without major cutbacks when treating ITBFS. Most other overuse syndromes require major training changes.

### Literature References

In addition to the text of the post-visit summary, the treating physician may select literature references for the patient. Particularly, the physician may select lay literature appropriate to the condition. The literature available for selection by the physician may be chosen by the content physician, with the assistance of a librarian, who can provide literature search services for the content physician.

### MD Educational Material

Prior to the patient visit, the treating physician may be provided with a pre-visit physician report that includes educational material regarding the patient's condition(s). This educational material may have four segments: 1) differential diagnosis, 2) work-up algorithms, 3) treatment considerations or algorithms, and 4) literature references. Regarding 4), combinations of classic review articles, text references, recent articles, and treatment algorithms are made available to the subscribing physician, based upon the condition. This information is available for reference after the visit as well.

The condition-specific content for the physicians varies from condition to condition. For example, a differential diagnosis list and a work up algorithm may be provided for symptoms, whereas with a true condition a treatment algorithm or some treatment considerations may be included.

In one embodiment the material in the pre-visit physician report is available to the subscribing physician via links on the browser screen, triggered by the condition or conditions for which the patient is being seen. If the physician makes a diagnosis different than the condition for which the patient is being seen (a common occurrence, especially when the presenting complaint is a symptom), he will have the option of calling up the references for the new diagnosis.

Following is an example of a differential diagnosis list and a work-up algorithm in which hip pain is a symptom

### Hip Pain Differential Diagnosis List—Middle Age Adult

1) True hip joint source

a) Arthritis

i) Osteoarthritis

ii) Inflammatory arthritis

iii) Septic arthritis

iv) Post Traumatic arthritis

v) Others

b) Avascular necrosis

c) Stress or insufficiency fracture

d) Trauma

e) Synovitis

i) Gout

ii) Pseudo-gout

iii) Injury/repetitive stress induced synovitis

f) Tumor

2) Periarticular sources

a) Tendonitis

b) Muscle or tendon strains (usually adductor tendon)

c) Trochanteric bursitis (often secondary to back problems)

d) Psoas tendon or muscle pain

i) Bleed (Especially if on anticoagulants)

ii) Abscess

e) Tumor

3) Low back sources

a) Lumbar disc disease

b) Lumbar degenerative disease (facet arthritis, etc.)

c) Spinal stenosis

d) Spondylolithesis

e) Infection

Following is an abbreviated work up algorithm for hip pain for a middle age adult

### EXAMPLE: Work-up Algorithm for Hip Pain

1) Trauma?

a) Yes—Plain x-ray

i) Positive for fracture—Treat

ii) Negative

(1) High suspicion for occult fracture/?

(a) Yes—MRI or bone scan—urgent

(b) No—Crutches, walker or cane for symptomatic relief and observation

b) No—go to routine hip pain evaluation

2) Routine evaluation for patient without sudden trauma

a) Symptoms suggesting hip problem (groin, anterior thigh pain, difficulty with shoes and socks, in and out of car, etc.) and hip exam abnormal with loss of motion, pain with motion, limp, or weight bearing pain

i) Yes

(1) Plain x ray first study

(a) Positive—treat per findings

(b) Normal

(i) Observe

(ii) Further study based on degree of suspicion would be:

(iii) Bone scan or

(iv) MRI

ii) No—the symptoms are not classic hip joint symptoms and the exam of the hip is normal

(1) Consider the back as the source

(a) Symptoms, history and exam suggest possible back problem

(i) Observe/conservative care

1. Plain lumbar films including AP pelvis if no better

b) If symptoms suggest tumor—push the work up with plain films and consider early MRI or bone scan

### EXAMPLE: Treatment Options for Osteoarthritis of the Hip

1) Most patients can be managed non-operatively—the components of general management are as follows:

a) Pain control

i) Tylenol/acetaminophen is first line care because of good pain relief and low side effects

ii) Anti-inflammatory agents are second line—can be effective but with higher sided effect ratios that acetaminophen

iii) Other pain relievers such as codeine, propoxyphene. Have limited use for short periods of time because of possible side effects and habituation

b) Weight control

i) Overweight patients put added stress on the hip in activities of daily living and in attempts at some forms of aerobic conditioning

c) Cane (usually in opposite hand)

i) Effectively relieves a surprising amount of weight from the hip but is difficult to talk patients into.

d) Exercises for the hip—can be taught in 1-2 physical therapy visits or by the physician

i) Flexibility

ii) Abductor strengthening

e) Aerobic exercise which needs to be low impact

i) Swimming

ii) Water exercise

iii) Bike

iv) Low impact aerobics

f) Avoidance of

i) High impact activities such as running

2) Although most patients will not need an operation for osteoarthritis of the hip, if the pain is significant after appropriate conservative care, an operation may be helpful for the patient. Orthopedic referral is appropriate for consideration of

a) Total hip replacement

b) Osteotomy in selected cases

### Alternative Embodiments

It will be appreciated by those skilled in the art, in view of these teachings, that alternative embodiments may be implemented without deviating from the spirit or scope of the invention. This invention is to be limited only by the following claims, which include all such embodiments and modifications when viewed in conjunction with the above specification and accompanying drawings.

What is claimed is:

1. A method for creating a medical chart regarding a patient's medical condition for which an appointment has been scheduled with a physician, comprising:
enabling said patient to access a server site, and enabling said condition at said server site;
connecting said patient to said server site;
interactively interviewing said patient by said server site regarding said enabled condition, and storing information from said patient regarding said condition in patient files at said server site;
responsive to said interview, electronically generating, by said server site, pre-visit information that includes an editable preliminary chart note including information relating to said patient's condition; and
transmitting said preliminary chart note to said physician.

2. The method of claim 1 further comprising, after examining said patient by said physician:
completing said patient's chart note by said physician responsive to said examination; and
storing said completed chart note at said server site.

3. The method of claim 1 further comprising electronically generating pre-visit information responsive to said interview that includes a pre-visit physician report including expert medical information relating to said patient's condition, and transmitting said report to said physician.

4. The method of claim 3 wherein said pre-visit physician report includes at least one of differential diagnoses, work-up algorithms, treatment considerations, and literature references, and transmitting said pre-visit physician report to said physician.

5. The method of claim 1 further comprising electronically generating pre-visit information that includes a pre-visit patient summary responsive to said interview including information relating to said patient's condition, and transmitting said pre-visit patient summary to said patient.

6. The method of claim 5 wherein said step of electronically generating said pre-visit patient summary further comprises electronically generating key questions relating to said condition, and transmitting said key questions to said patient.

7. The method of claim 6 wherein said step of electronically generating said pre-visit information further comprises electronically generating a pre-visit physician report that includes said key questions and a rationale for each of said questions, and transmitting said pre-visit physician report to said physician.

8. The method of claim 1 further comprising, after examining said patient by said physician, generating a post-visit patient report, and transmitting said post-visit report to said patient

9. The method of claim 1 further comprising:
responsive to said interview, electronically generating a pre-visit patient summary relating to said patient's condition, said pre-visit summary including a plurality of key questions relating to said conditions, and transmitting said report to said patient;
responsive to said interview, electronically generating a pre-visit physician report including expert medical information relating to said patient's condition, said pre-visit physician report also including said plurality of key questions and a rationale for each of said questions, and transmitting said pre-visit physician report to said physician.

10. The method of claim 9 wherein said pre-visit physician report further includes at least one of differential diagnoses, work-up algorithms, treatment considerations, and literature references, and transmitting said pre-visit physician report to said physician.

11. A method for creating a medical chart regarding an office visit for a specific condition of a patient, comprising:
providing a server site connected to an electronic communication network, said server site including storage of patient files for a plurality of patients including said patient;
connecting said patient to said server site using said electronic communication network;
interviewing said patient by said server site regarding said specific condition, and storing information from said patient regarding said specific condition in said patient's files at said server site;
electronically generating, by said server site, pre-visit information that includes a pre-visit patient summary and a preliminary chart note, and transmitting said pre-visit patient summary to said patient and said preliminary chart note to said physician;
examining said patient by said physician;
completing said patient's chart note by said physician responsive to said examination; and
storing said completed chart note at said server site.

12. The method of claim 11 further comprising:
selecting, by said physician, condition-specific educational material to be provided to said patient; and
responsive to said completed chart note and said selected material, electronically generating a post-visit report for said patient.

13. The method of claim 11, further comprising the step of providing a plurality of key questions to said patient with said pre-visit summary, and supplying said plurality of pre-visit questions to said physician prior to said patient's visit.

14. The method of claim 11 further comprising
supplying an access code associated with a patient to emergency personnel assigned to treat said patient; and
utilizing said access code to connect to said server site and view said patient's file to assist in treating said patient.

15. The method of claim 11 further comprising, by said patient:
subsequently logging onto said server site;
viewing said patient's file; and
updating said patient's file.

16. The method of claim 11 further comprising:
electronically storing a group of patient files without patient identifiers such that said patient files avoid disclosing the identity of the patients associated with said files, and;
performing medical studies utilizing said group of patient files.

17. A method for assisting a physician in providing medical services to a patient who has a medical condition, comprising:
providing a server site connected to an electronic communication network, said server site including storage of patient files for a plurality of patients including said patient;
providing a patient with access information for logging on to said server site;
logging onto said server site by said patient, and in response to a request by said patient, registering said patient including creating an electronic file for said patient in said patient record database;
conducting a pre-visit interview of said patient using electronically selected information including interactively interviewing said patient in preparation for a medical consultation, and responsive to said pre-visit interview, electronically storing responses of said patient in said patient's electronic file;
responsive to said pre-visit interview, electronically generating a pre-visit summary that includes condition-specific preliminary information and transmitting said pre-visit summary to said patient; and
responsive to said pre-visit interview, electronically generating pre-visit information that includes a preliminary chart note and condition-specific educational material, and transmitting said pre-visit information to said physician.

18. The method of claim 17 further comprising protecting the security of all transmissions to and from said server site over said electronic communication network, including encrypting said transmissions, and further including protecting the privacy of said patient's file on said server site.

19. The method of claim 17, further comprising the step of providing a plurality of key questions to said patient with said pre-visit summary, and supplying said plurality of pre-visit questions to said physician with said pre-visit information.

20. The method of claim 17, further comprising:
examining said patient by said physician, and responsive to said examination, completing said patient's chart note by said physician and transmitting said completed chart note to said server site for storage in said patient's file;
responsive to said examination, electronically selecting condition-specific educational material to be provided to said patient, and transmitting said selected material to said server site for storage in said patient's file; and
responsive to said completed chart note and said selected material, electronically generating a post-visit report for said patient.

21. The method of claim 17 further comprising, by said patient:
subsequently logging onto said server site;
viewing said patient's file; and
updating said patient's file.

22. The method of claim 17 further comprising, by said physician:
subsequently logging onto said server site;
viewing said patient's file unless said patient has previously updated said patient's file to de-select said physician.

23. The method of claim 17 further comprising:
electronically storing a group of patient files without patient identifiers such that said patient files avoid disclosing the identity of the patients associated with said files, and;
performing medical studies utilizing said group of patient files.

24. A medical information system that utilizes an electronic communication network for facilitating delivery of medical services from physicians to patients, and for electronically storing patient files, comprising:
a communication link to said electronic communication network;
a plurality of databases stored in computer-readable form, including condition-specific medical information and individual patient files;
a plurality of computer programs connected to said databases and said communication link;
a system for providing an interactive interview for said patient and storing responses thereto in said patient's file;
a system, responsive to said interview, for generating a condition-specific pre-visit summary for said patient in preparation for a visit by said patient to a physician; and
a system, responsive to said interview, for generating pre-visit condition-specific material including a preliminary chart note for the physician in advance of said visit by said patient.

25. The system of claim 24 wherein said databases include a database including key questions, and further comprising a system for selecting and providing a plurality of key questions to said patient with said pre-visit summary, and a system for supplying said plurality of pre-visit questions to said physician with said pre-visit information.

26. The system of claim 24 further comprising means for protecting the security of all transmissions to and from said server site over said electronic communication network, including encrypting said transmissions, and further including means for protecting the privacy of said patient's file on said server site.

27. The system of claim 24 further comprising:
a system for said physician to complete said patient's chart note, and transmitting said completed chart note to said server site for storage in said patient's file;
a system for electronically selecting condition-specific educational material to be provided to said patient, and transmitting said selected material to said server site for storage in said patient's file; and
a system, responsive to said completed chart note and said selected material, that electronically generates a post-visit report for said patient.

28. The system of claim 24 further comprising a system for allowing said patient to update said patient's file.

29. The system of claim 24 further comprising a system for allowing a physician to view said patient's file only if said physician has been pre-authorized by said patient.

30. The system of claim 24 further comprising a system for allowing emergency personnel to view said patient's file.

31. The system of claim 24 further comprising a system for performing medical studies utilizing said group of patient files.

32. A computerized method of clinically educating a physician over an electronic network, comprising the steps of:
interviewing a plurality of patients, each patient having one or more of a plurality of medical conditions;
for each patient, generating a report in computerized form for said physician that includes condition specific information regarding medical practices relating to said one or more medical conditions applicable to said patient; and
prior to each of said consultations, providing said physician with said condition-specific information in computerized form regarding medical practices relating to said one or more medical conditions applicable to said patient, thereby clinically educating said physician with updated medical practices relating to said one or more medical conditions.
